(19) United States
(12) Patent Application Publication
(10) Pub. No.: US 2019/0050097 A1
(43) Pub. Date: Feb. 14, 2019

(54) TOUCH PANEL-EQUIPPED DISPLAY DEVICE

(71) Applicant: SHARP KABUSHIKI KAISHA, Sakai City, Osaka (JP)

(72) Inventor: JEAN MUGIRANEZA, Sakai City (JP)

(21) Appl. No.: 16/086,602

(22) PCT Filed: Mar. 24, 2017
(86) PCT No.: PCT/JP2017/012011

§ 371 Date: Sep. 20, 2018

(30) Foreign Application Priority Data
Mar. 30, 2016 (JP) 2016-068576

(51) Int. Cl. G06F 3/041; G02F 1/1333; G06F 3/044

(52) U.S. Cl. CPC G06F 3/0412; G02F 1/13338; G06F 2203/04107; G06F 3/0418; G06F 3/044

(57) ABSTRACT

A touch position on a touchscreen on which a water drop is present is accurately detected. A touchscreen-equipped display device (1) includes touchscreen (4) and a touchscreen controller (10), the touchscreen (4) including: a transmitter electrode (T); a first receiver electrode (SA) for readout of a first signal based on a first capacitance between the first receiver electrode (SA) and the transmitter electrode (T); and a second receiver electrode (SB) that is more distant from the transmitter electrode (T) than the first receiver electrode (SA) is from the transmitter electrode (T) and that is for readout of a second signal based on a second capacitance between the second receiver electrode (SB) and the transmitter electrode (T), the controller (10) being configured to, when a water drop is present on the touchscreen (4), increase a frequency at which the second signal read out.

### TECHNICAL FIELD

The present invention relates to a touchscreen-equipped display device.

### BACKGROUND ART

The following capacitive touchscreen is known as a touchscreen for operating a display panel: a capacitive touchscreen that includes (i) a transmitter electrode driven by a driving voltage, (ii) a first receiver electrode for readout of a first signal based on a first capacitance between the first receiver electrode and the transmitter electrode, and (iii) a second receiver electrode that is more distant from the transmitter electrode than the first receiver electrode is from the transmitter electrode and that is for readout of a second signal based on a second capacitance between the second receiver electrode and the transmitter electrode (Patent Literature 1).

The capacitive touchscreen disclosed in Patent Literature 1 determines whether or not a detection target is a conductor on the basis of (i) a change that would occur in the capacitance between the transmitter electrode and the first receiver electrode when the detection target approaches the touchscreen and (ii) a change that would occur in the capacitance between the transmitter electrode and the second receiver electrode when the detection target approaches the touchscreen.

### CITATION LIST

### Patent Literature

[Patent Literature 1]

Specification of U.S. Patent Application Publication No. 2015/0179122 (Publication Date: Jan. 25, 2015)

### SUMMARY OF INVENTION

### Technical Problem

However, the conventional technique like that described above has an issue in that a touch cannot be detected properly if the touchscreen is wet with water.

(a), (b), and (c) of FIG. 34 are cross-sectional views schematically illustrating the issue that arises when a water drop is present on a touchscreen. For simplicity of description, the foregoing first and second receiver electrodes are collectively referred to as receiver electrodes R in the following description.

A capacitive touchscreen 4 includes a plurality of transmitter electrodes T and a plurality of receiver electrodes R, which are disposed on a liquid crystal panel 2. As illustrated in (a) of FIG. 34, in a region touched by a finger (detection target), the mutual capacitance between a transmitter electrode T and a receiver electrode R decreases. On the other hand, in a region not touched by a finger, the mutual capacitance between a transmitter electrode T and a receiver electrode R does not decrease. This enables detection of the position touched by a finger.

If the surface of the capacitive touchscreen 4 is wet with a water drop W as illustrated in (b) of FIG. 34, a significant increase is induced in the mutual capacitance between a transmitter electrode T arid a receiver electrode R. Water is a dielectric substance that has a high dielectric constant (ε=80), but is also a good conductor of electricity. Due to the high dielectric constant of water, the change in capacitance is large enough to cause confusion in touch signals. Even though the change in capacitance caused by a water drop is an increase unlike the decrease caused by a touch by a finger, it is difficult for the conventional touchscreen controller to effectively avoid the change in capacitance that would be caused by a water drop.

When the water drop W is touched, the mutual capacitance between a transmitter electrode T and a receiver electrode R significantly decreases. Water is a good conductor of electricity and, due to this conductivity of water, it is not possible to detect the touch position accurately.

The present invention was made in view of the above issue, and an object thereof is to provide a touchscreen-equipped display device that is capable of accurately detecting a touch position on a touchscreen on which a water drop is present.

### Solution to Problem

In order to attain the above object, a touchscreen-equipped display device in accordance with one aspect of the present invention includes: a display panel; a touchscreen via which the display panel is operated; and a controller configured to control the touchscreen, the touchscreen including: a transmitter electrode configured to be driven by a driving voltage; a first receiver electrode for readout of a first signal based on a first capacitance between the first receiver electrode and the transmitter electrode; and a second receiver electrode that is more distant from the transmitter electrode than the first receiver electrode is from the transmitter electrode and that is for readout of a second signal based on a second capacitance between the second receiver electrode and the transmitter electrode, the controller being configured to, when a water drop is present on the touchscreen, increase a frequency at which the second signal is read out.

### Advantageous Effects of Invention

One aspect of the present invention brings about an effect of making it possible to accurately detect a touch position on a touchscreen on which a water drop is present.

### BRIEF DESCRIPTION OF DRAWINGS

FIG. 1 is a plan view illustrating a touchscreen-equipped display device in accordance with Embodiment 1.

(a), (b), (c), and (d) of FIG. 2 are cross-sectional views illustrating a concept of how the touchscreen-equipped display device detects a finger wet with a water drop.

(a) of FIG. 3 is a cross-sectional view illustrating a concept of how a finger wet with a water drop is detected at a lower readout frequency, and (b) of FIG. 3 is a graph showing the relationship between a touch signal and a detected position in the situation of (a) of FIG. 3.

(a) of FIG. 4 is a cross-sectional view illustrating a concept of how a finger wet with a water drop is detected at a higher readout frequency, and (b) of FIG. 4 is a graph showing the relationship between a touch signal and a detected position in the situation of (a) of FIG. 4.

FIG. 5 is a circuit diagram showing a relationship between a capacitive touchscreen and a touchscreen controller, which are included in the touchscreen-equipped display device.

FIG. 6 is a flowchart illustrating an operation of the touchscreen-equipped display device.

FIG. 7 shows graphs illustrating the results of detection of touch signals by the touchscreen-equipped display device. (a) of FIG. 7 illustrates the result of detection at low frequency, and (b) of FIG. 7 illustrates the result of detection at high frequency.

FIG. 8 shows graphs for explaining touch signals obtained by the touchscreen-equipped display device at 100 kHz in a case of a wet finger. (a) of FIG. 8 shows a signal in a condition in which no touch is made in a dry environment, (b) of FIG. 8 shows a touch signal in a condition in which a touch is made in a dry environment, (c) of FIG. 8 shows a signal in a condition in which no touch is made in a water drop environment, and (d) of FIG. 8 shows a touch signal in a condition in which a touch is made in a water drop environment.

FIG. 9 shows graphs for explaining touch signals obtained by the touchscreen-equipped display device at 5 MHz in a case of a wet finger. (a) of FIG. 9 shows a signal in a condition in which no touch is made in a dry environment, (b) of FIG. 9 shows a touch signal in a condition in which a touch is made in a dry environment, (c) of FIG. 9 shows a signal in a condition in which no touch is made in a water drop environment, and (d) of FIG. 9 shows a touch signal in a condition in which a touch is made in a water drop environment.

FIG. 10 is a flowchart illustrating an operation of a touchscreen-equipped display device in accordance with Embodiment 2.

FIG. 11 is a flowchart illustrating another operation of the touch screen-equipped display device in accordance with Embodiment 2.

(a) of FIG. 12 is a plan view illustrating patterns of transmitter electrodes, first receiver electrodes, and second receiver electrodes provided in another touchscreen-equipped display device in accordance with Embodiment 2. (b) of FIG. 12 is a plan view illustrating other patterns of the transmitter electrodes, first receiver electrodes, and second receiver electrodes.

FIG. 13 is a perspective view illustrating touchscreen-equipped display device in accordance with Embodiment 3.

FIG. 14 is a cross-sectional view illustrating how a liquid crystal panel, a capacitive touchscreen, and a housing of the touchscreen-equipped display device are arranged.

FIG. 15 is a block diagram illustrating the above touchscreen-equipped display device.

FIG. 16 is a plan view schematically illustrating the above touchscreen-equipped display device.

FIG. 17 is an exploded view for explaining how the capacitive touchscreen and the housing of the above touchscreen-equipped display device are arranged.

FIG. 18 is a cross-sectional view schematically illustrating the above touchscreen-equipped display device.

FIG. 19 is a cross-sectional view schematically illustrating how transmitter electrodes and receiver electrodes of the above capacitive touchscreen and the housing are connected.

(a) of FIG. 20 is a graph illustrating a touch signal distribution detected when the housing of the above touchscreen-equipped display device is touched. (b) of FIG. 20 is a graph illustrating a touch signal distribution detected when a housing of a conventional touchscreen-equipped display device is touched.

(a) of FIG. 21 is a perspective view illustrating a touchscreen-equipped display device in accordance with Embodiment 2, and (b) of FIG. 21 is a perspective view illustrating another touchscreen-equipped display device in accordance with Embodiment 2.

FIG. 22 is a perspective view of a further touchscreen-equipped display device in accordance with Embodiment 4.

FIG. 23 is a plan view illustrating a touchscreen-equipped display device in accordance with Embodiment 5.

(a) and (b) of FIG. 24 are cross-sectional views schematically illustrating how a wire provided in a touchscreen of a touchscreen-equipped display device in accordance with Embodiment 6 is connected to a housing transmitter electrode disposed on a housing.

(a) of FIG. 25 is a plan view schematically illustrating a touchscreen-equipped display device in accordance with Embodiment 7, and (b) of FIG. 25 is a cross-sectional view schematically illustrating the touchscreen-equipped display device in accordance with Embodiment 7.

(a) of FIG. 26 is a plan view schematically illustrating a conventional touchscreen-equipped display device, and (b) of FIG. 26 is a cross-sectional view schematically illustrating the conventional touchscreen-equipped display device.

(a) of FIG. 27 is a plan view schematically illustrating another touchscreen-equipped display device in accordance with Embodiment 7, and (b) of FIG. 27 is a cross-sectional view schematically illustrating the another touchscreen-equipped display device in accordance with Embodiment 7.

(a) of FIG. 28 is a plan view schematically illustrating a further touchscreen-equipped display device in accordance with Embodiment 7, and (b) of FIG. 28 is a cross-sectional view schematically illustrating the further touchscreen-equipped display device in accordance with Embodiment 7.

(a) of FIG. 29 is a plan view schematically illustrating a conventional touchscreen-equipped display device, and (b) of FIG. 29 is a cross-sectional view schematically illustrating the conventional touchscreen-equipped display device.

(a) of FIG. 30 is a perspective view illustrating a touchscreen-equipped display device in accordance with Embodiment 8, and (b) of FIG. 30 is a circuit diagram of a proximity sensor disposed in the touchscreen-equipped display device in accordance with Embodiment 8.

(a) of FIG. 31 is a perspective view illustrating another touchscreen-equipped display device in accordance with Embodiment 8, (b) of FIG. 31 is a cross-sectional view schematically illustrating the another touchscreen-equipped display device in accordance with Embodiment 8, and (c) of FIG. 31 is a circuit diagram of an environment sensor included in the another touchscreen-equipped display device in accordance with Embodiment 8.

(a) of FIG. 32 is a perspective view illustrating a further touchscreen-equipped display device in accordance with Embodiment 8, and (b) of FIG. 32 is a cross-sectional view schematically illustrating the further touchscreen-equipped display device in accordance with Embodiment 8.

(a) of FIG. 33 is a perspective view of still another touchscreen-equipped display device in accordance with Embodiment 8, (b) of FIG. 33 is a cross-sectional view schematically illustrating the still another touchscreen-equipped display device in accordance with Embodiment 8, and (c) of FIG. 33 is a block diagram illustrating a relationship between a loop antenna, a near field communication reader, and a sense circuit, which are included in the still another touchscreen-equipped display device in accordance with Embodiment 8.

(a), (b), and (c) of FIG. 34 are cross-sectional views schematically illustrating the issue that arises when a water drop is present on a touchscreen.

### DESCRIPTION OF EMBODIMENTS

The following description will discuss embodiments of the present invention in detail.

### Embodiment 1

### Configuration of Touchscreen-Equipped Display Device 1

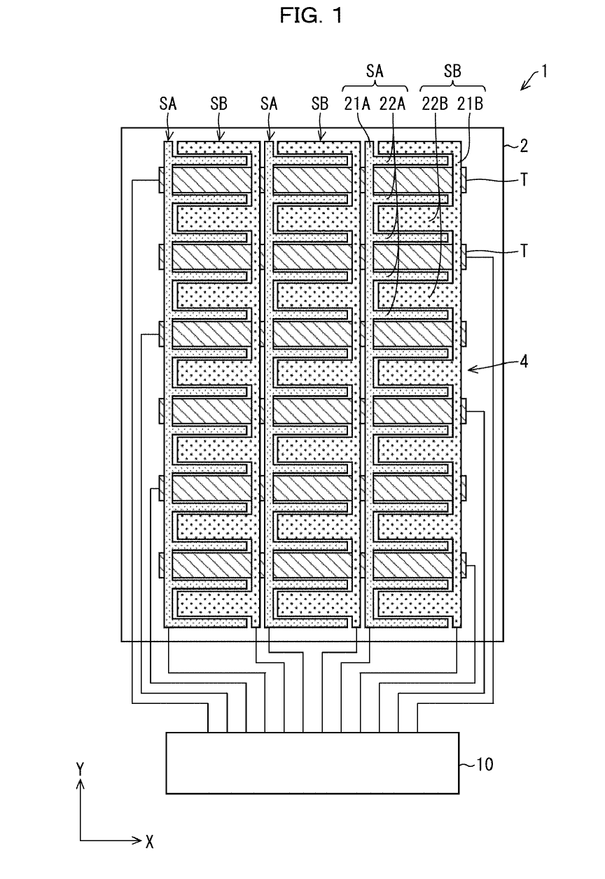

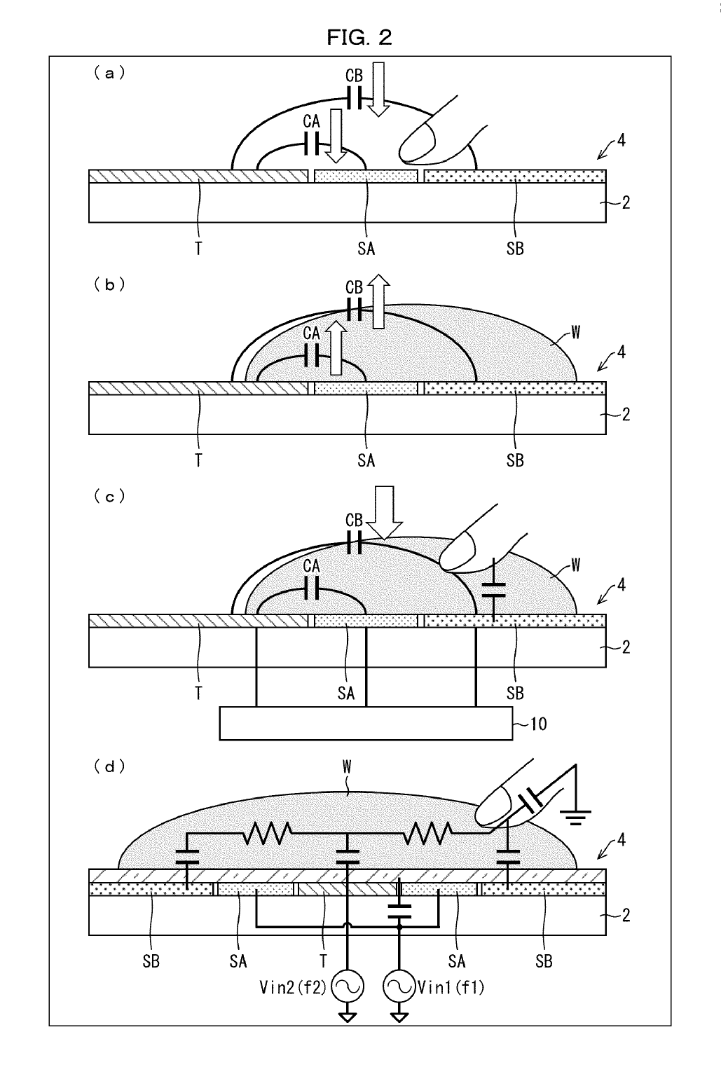

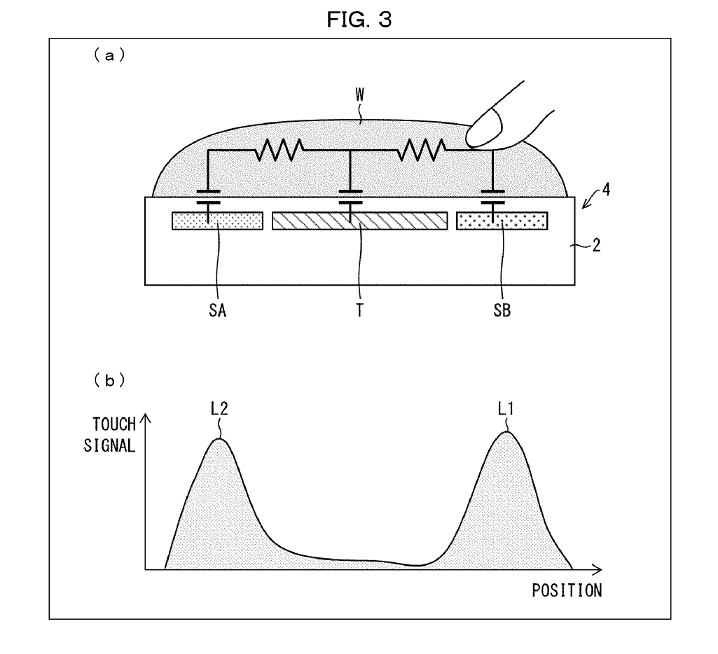

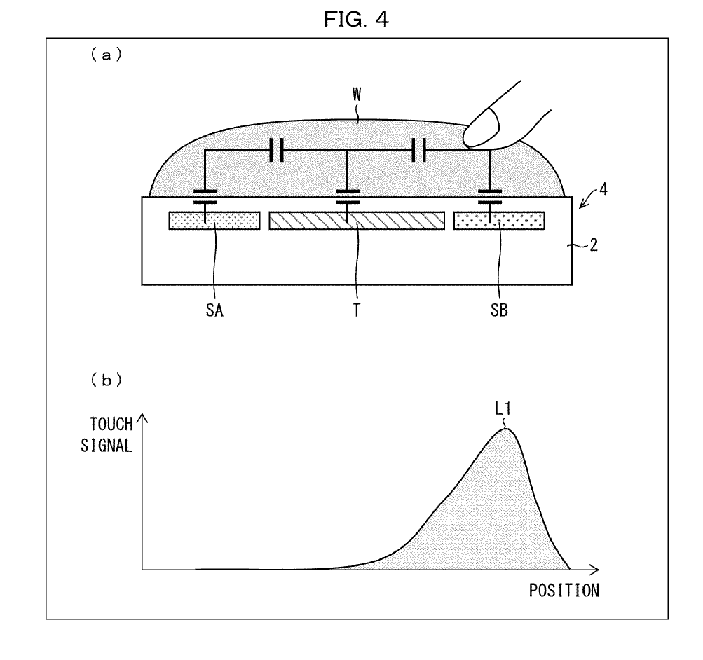

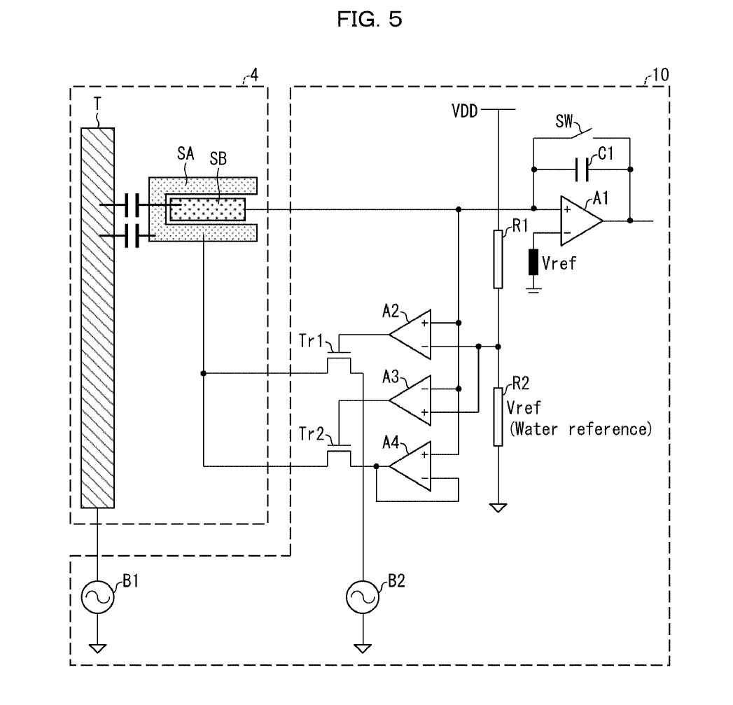

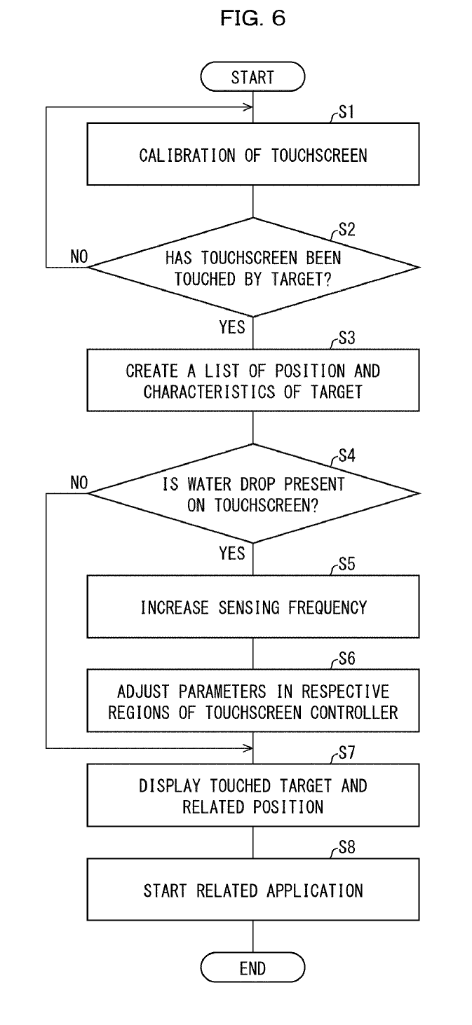

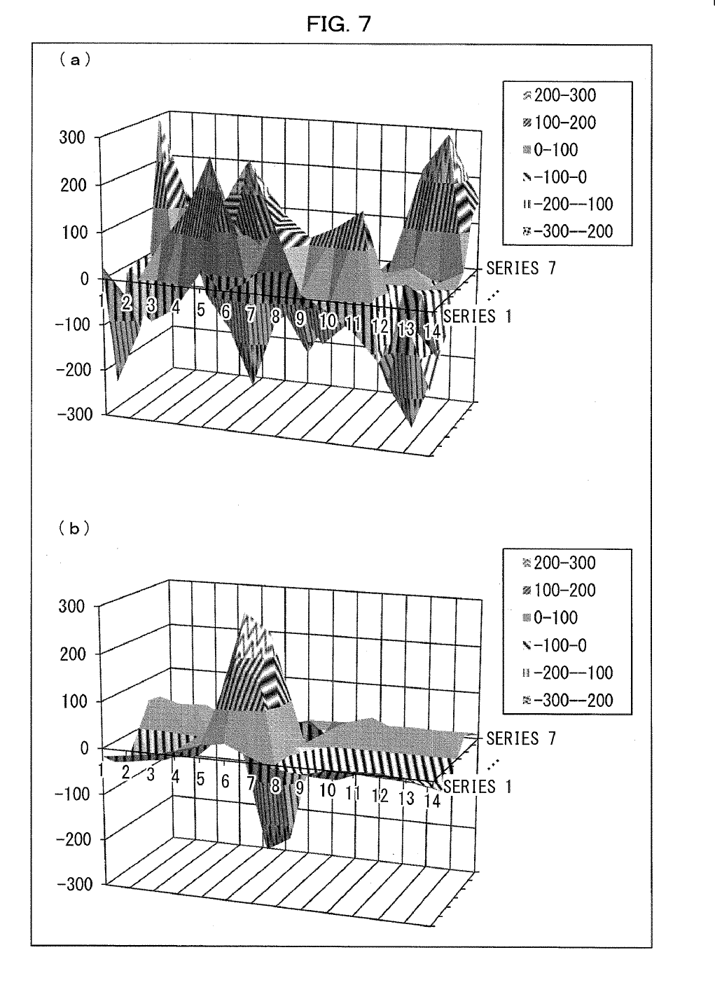

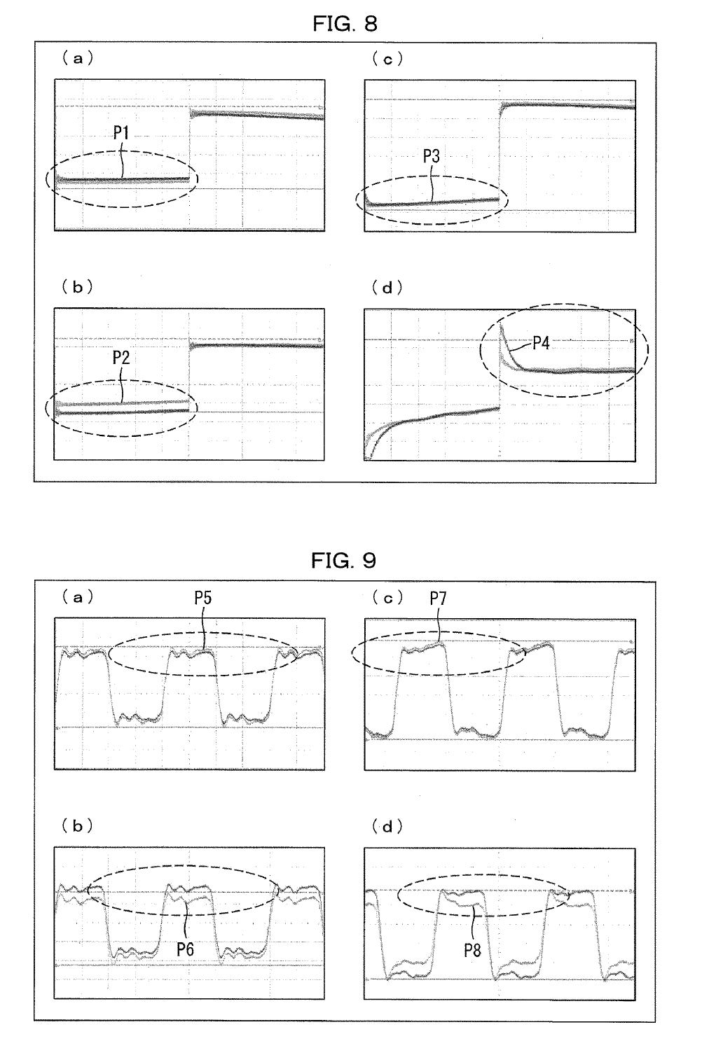

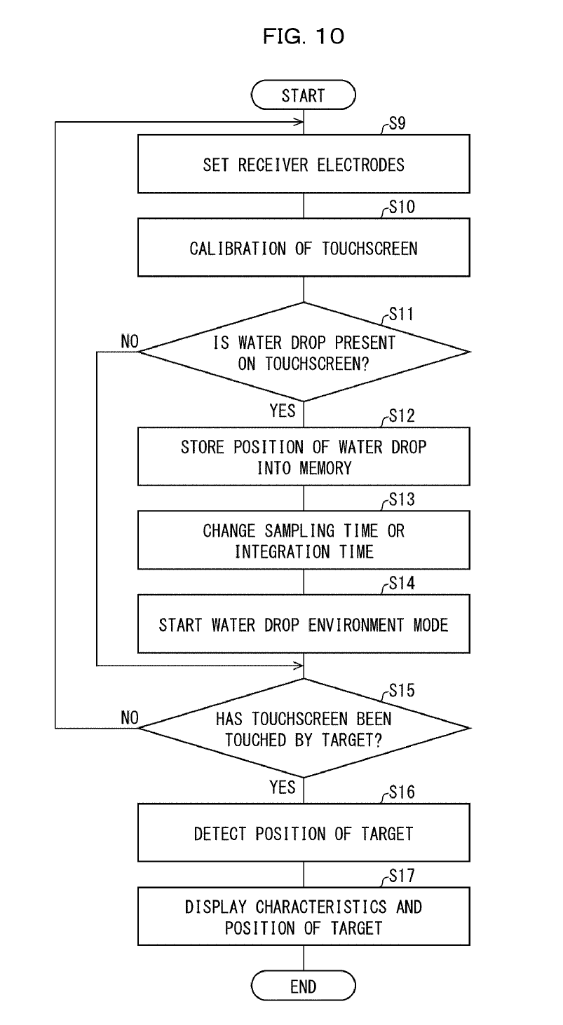

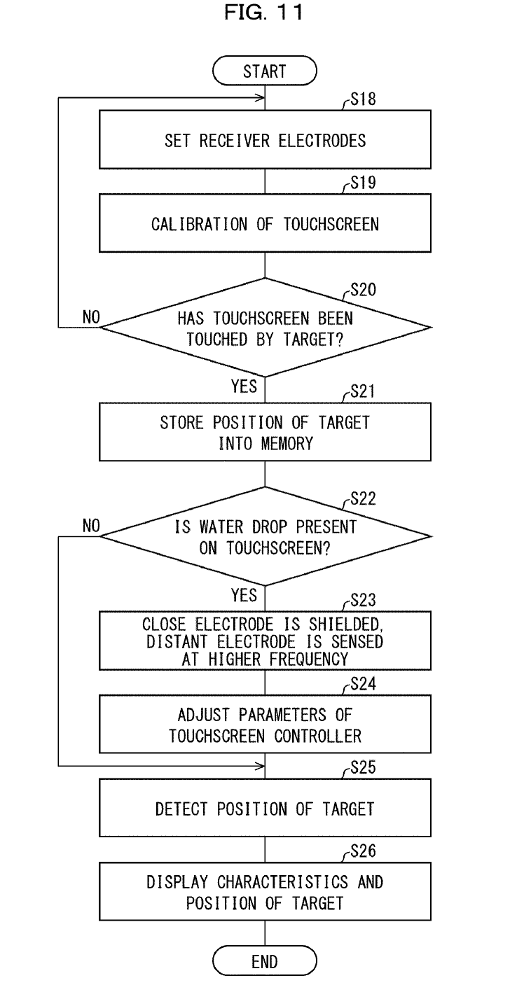

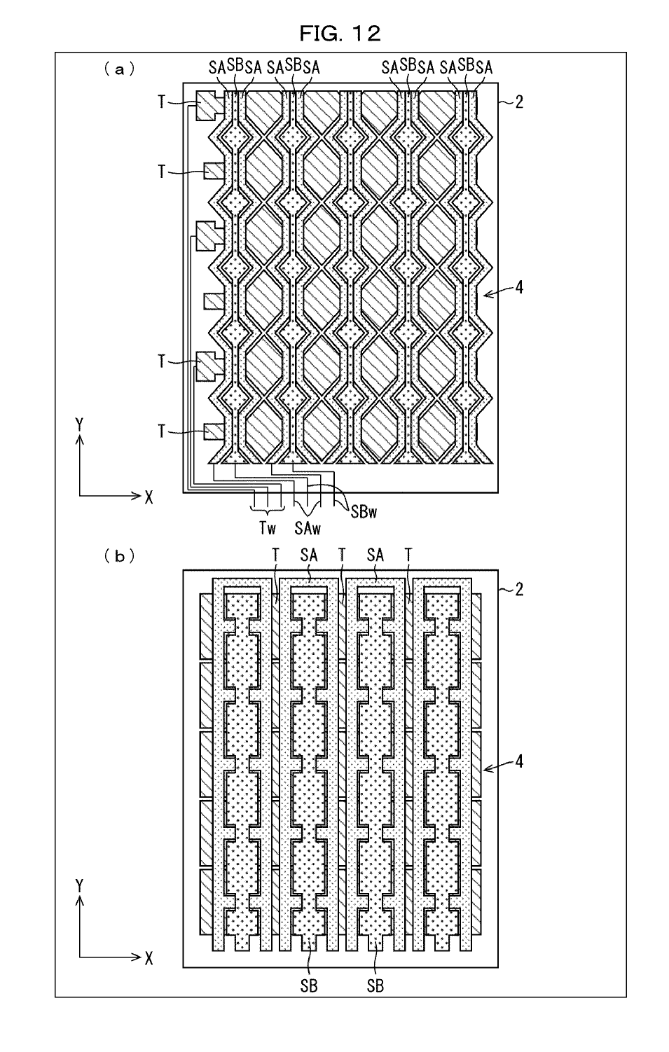

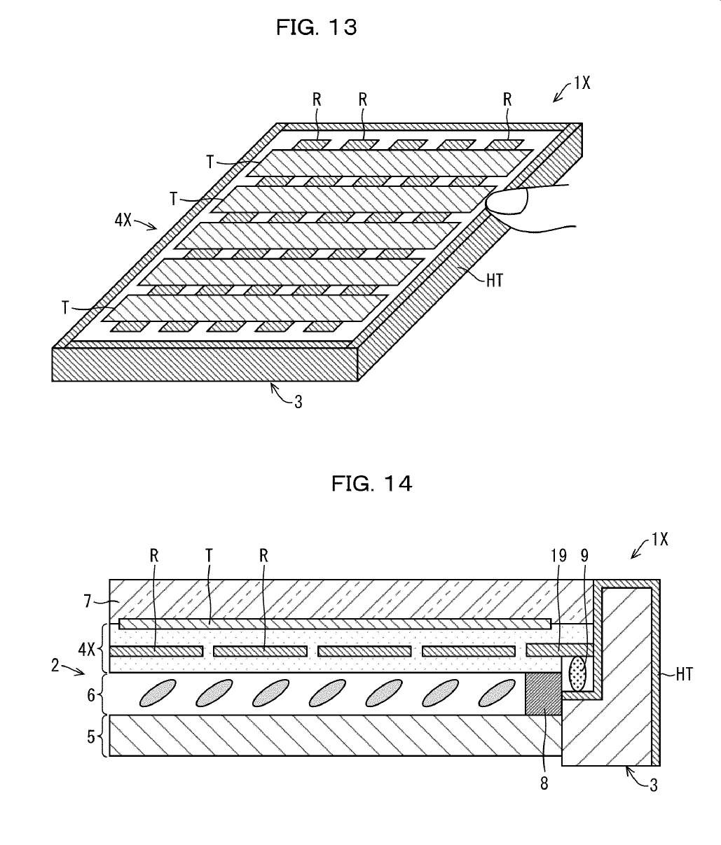

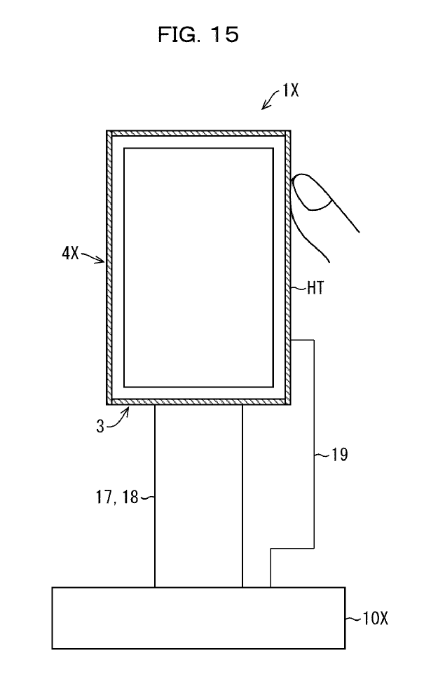

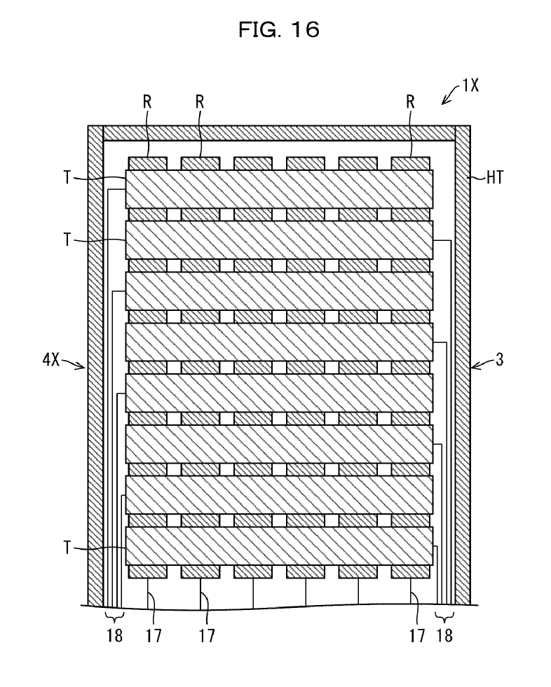

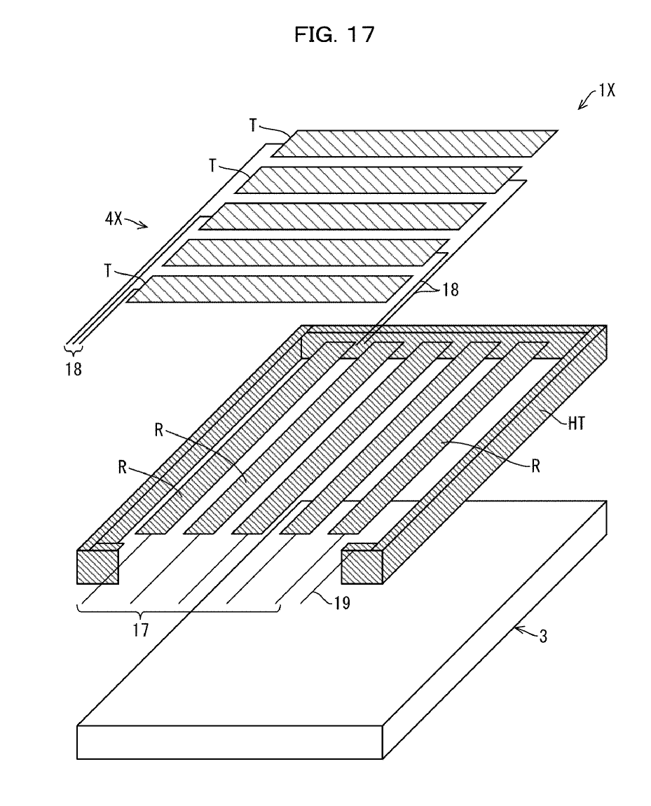

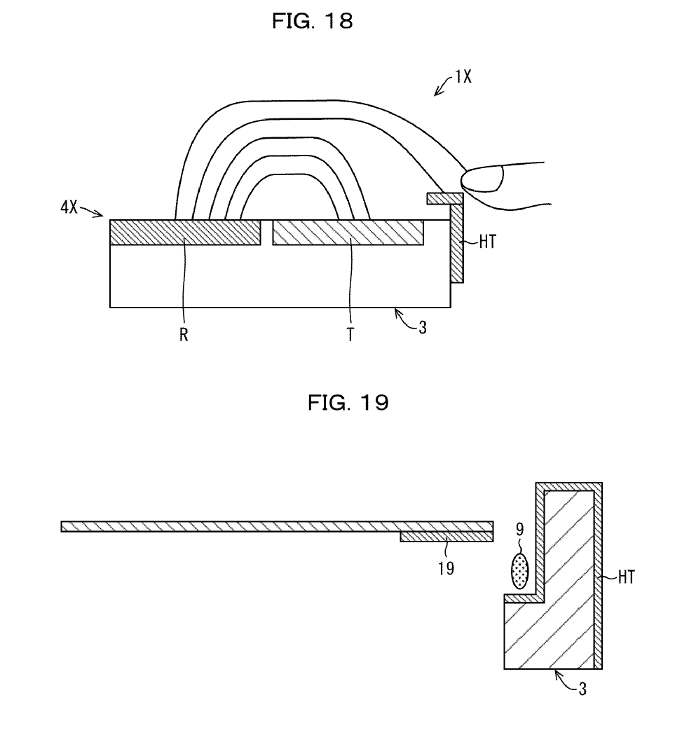

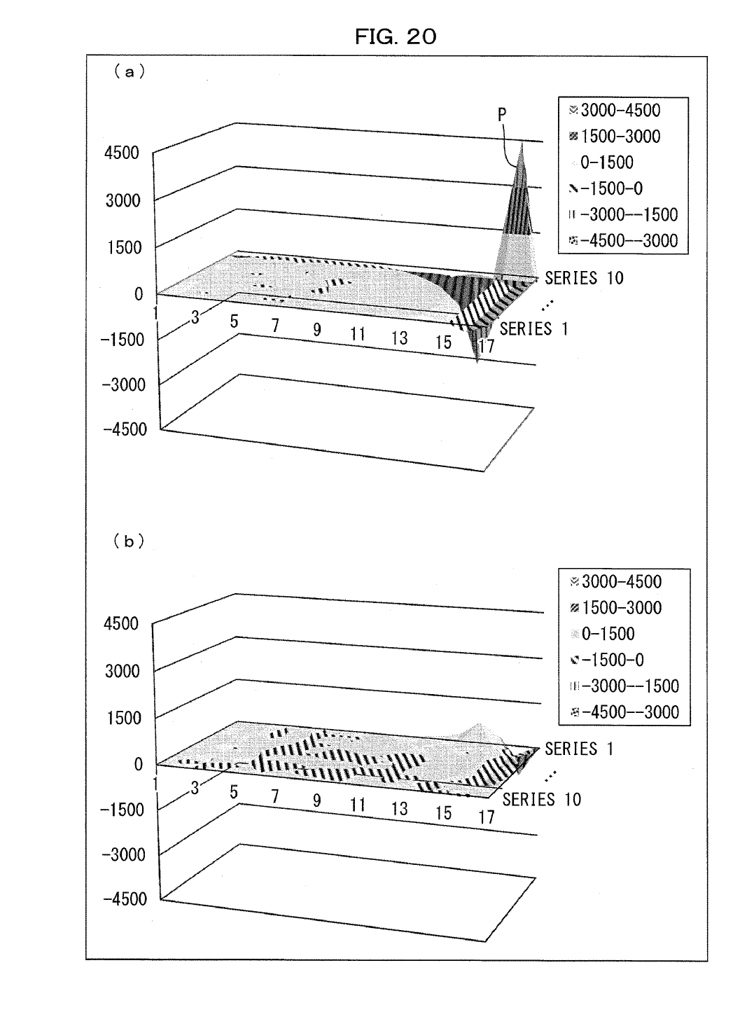

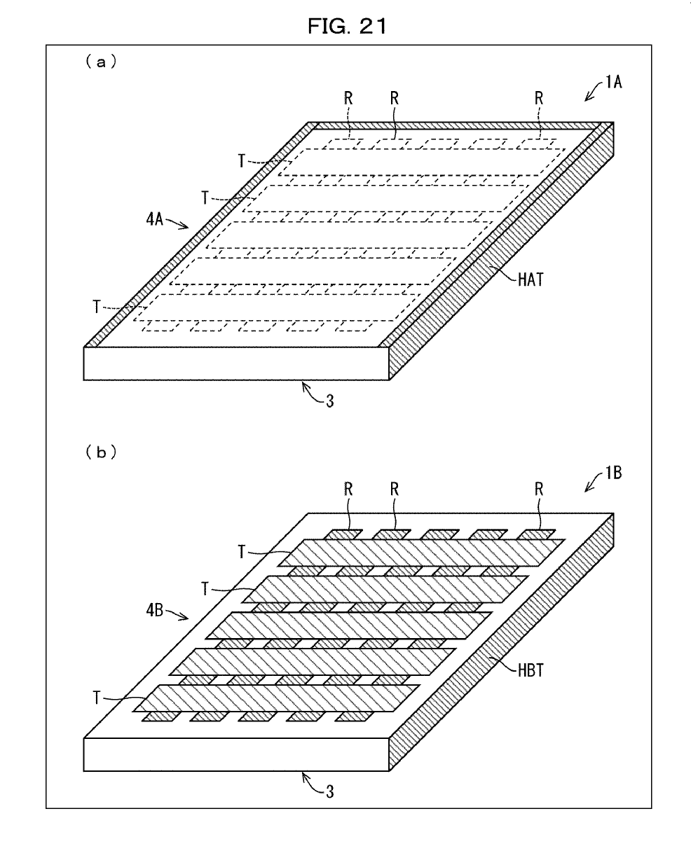

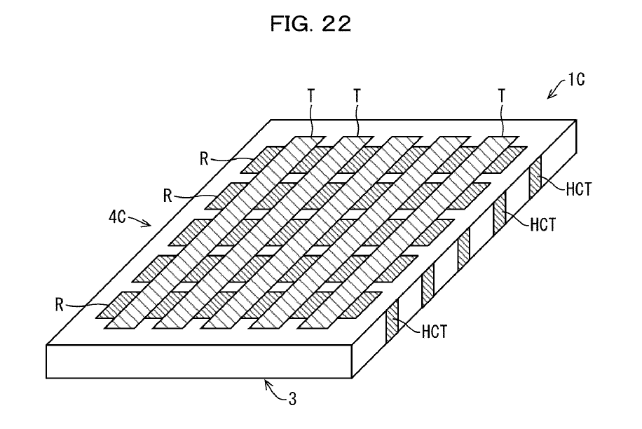

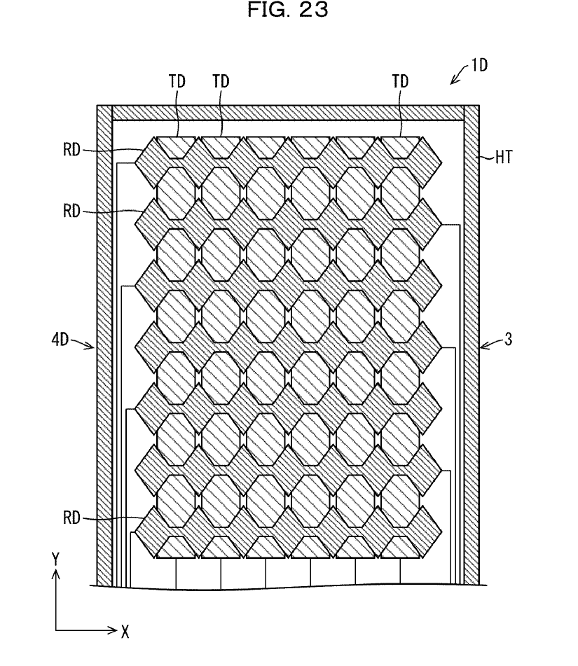

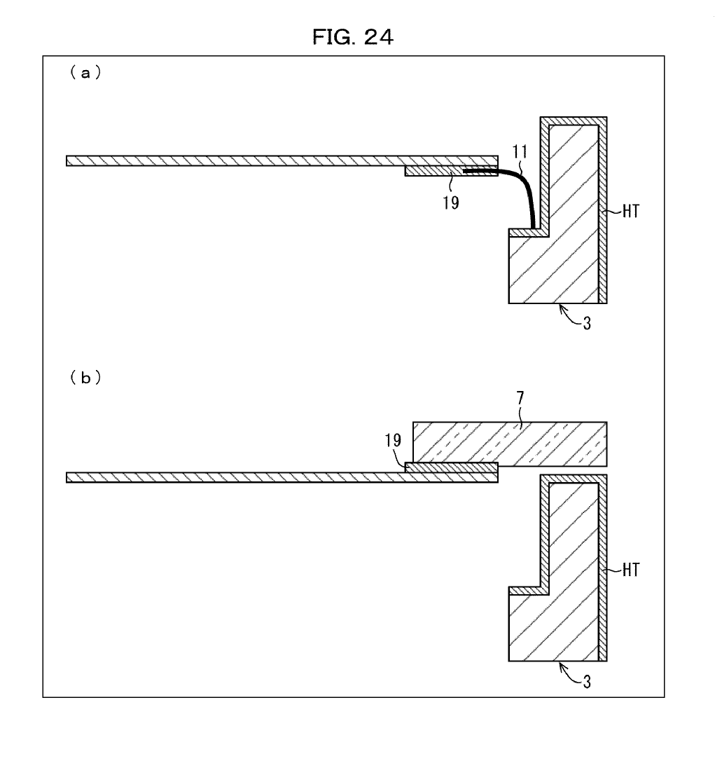

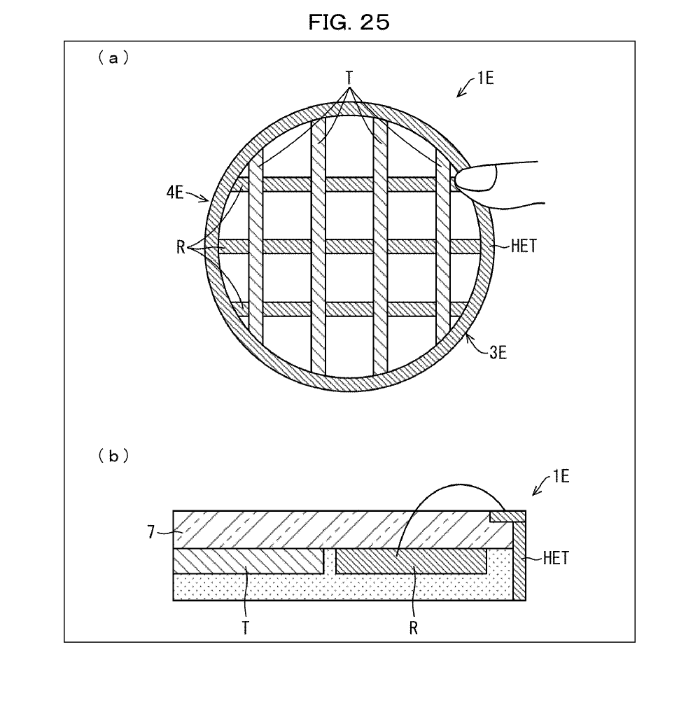

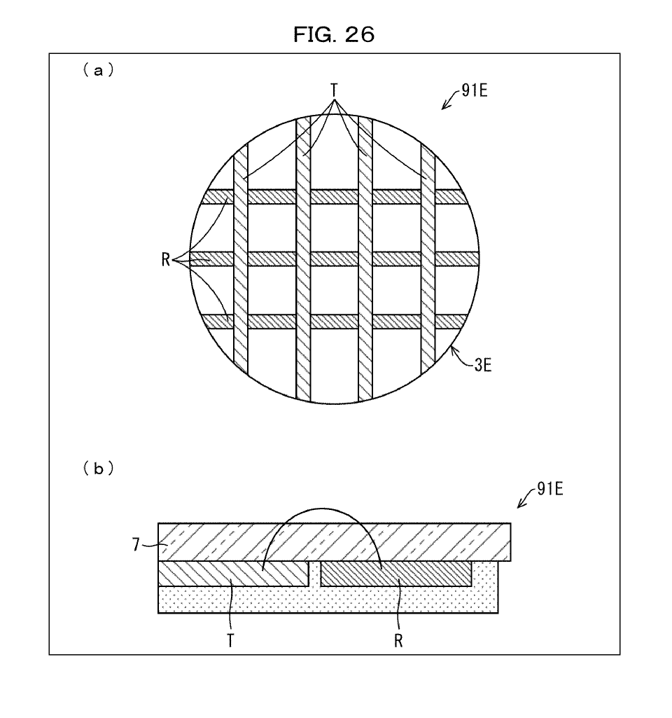

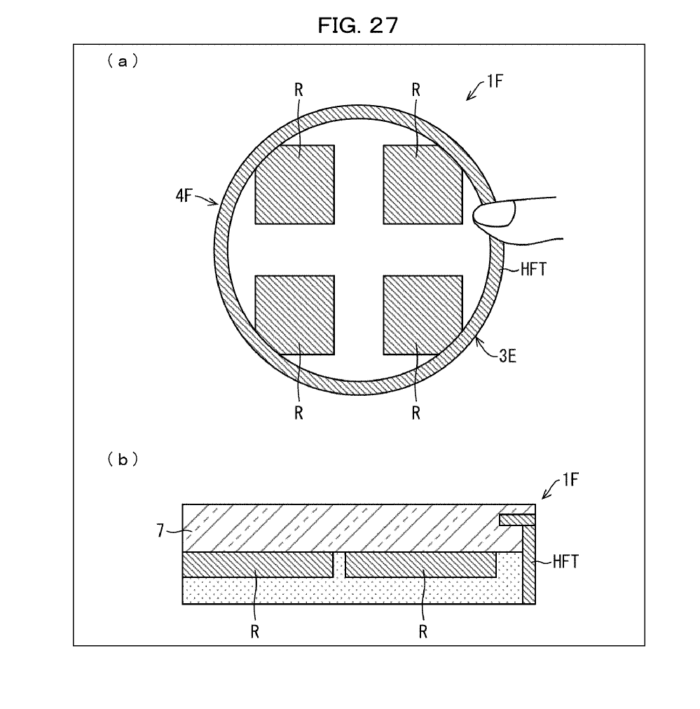

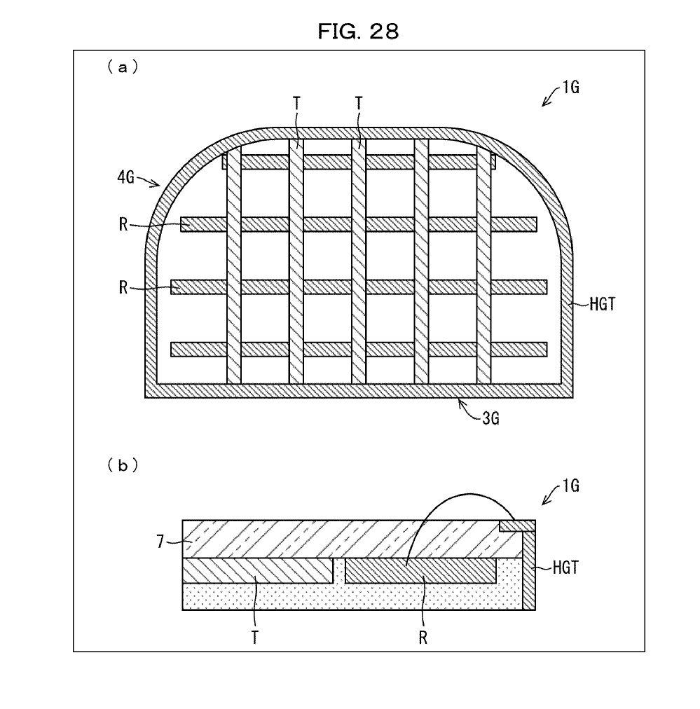

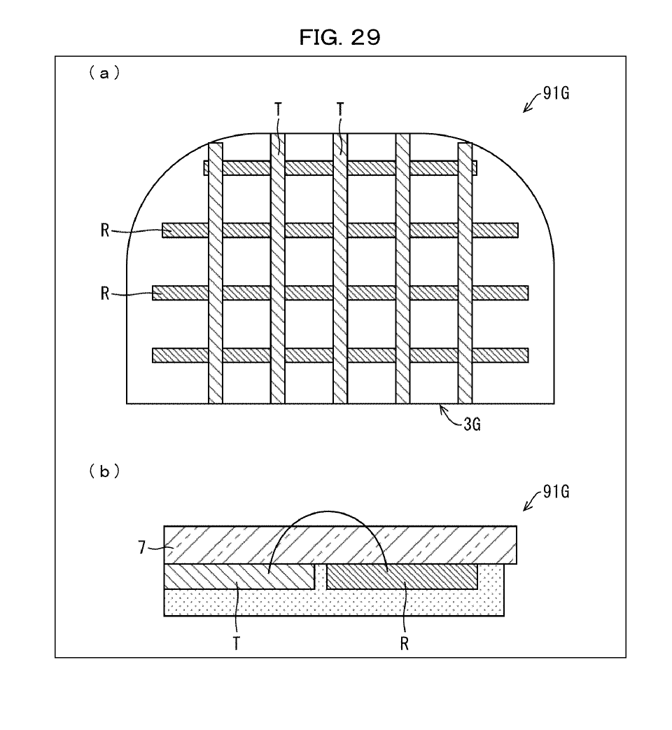

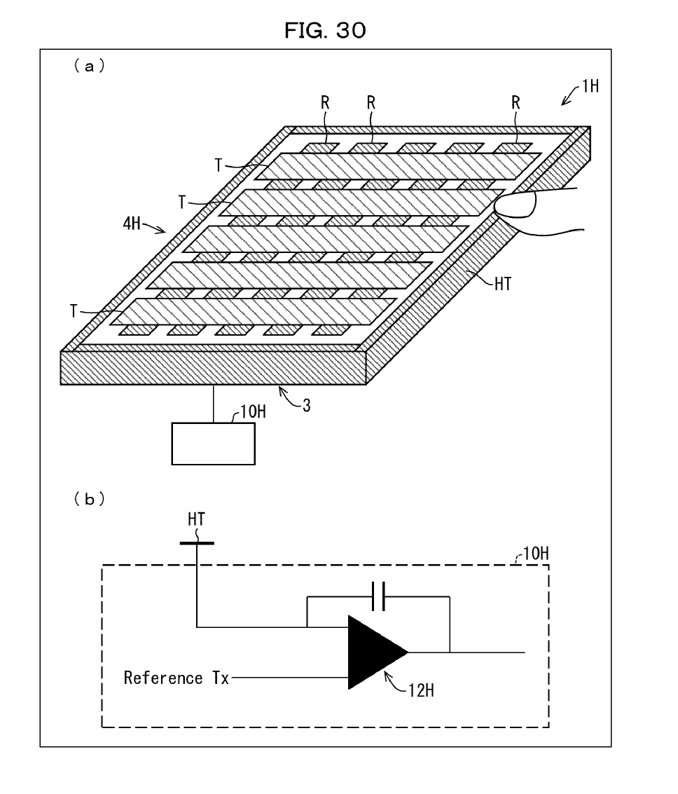

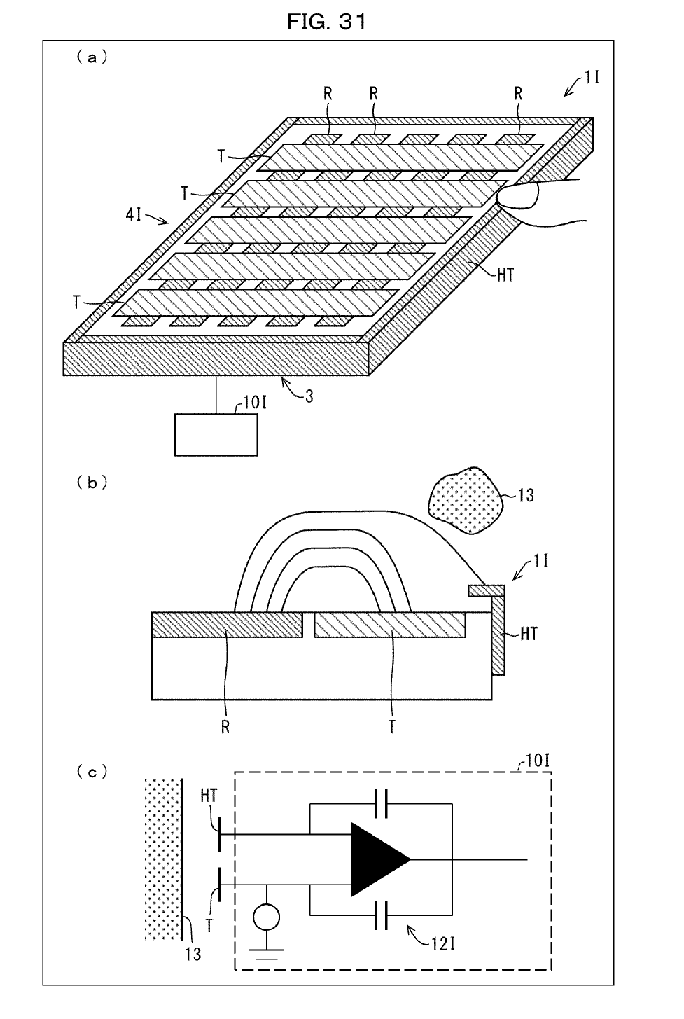

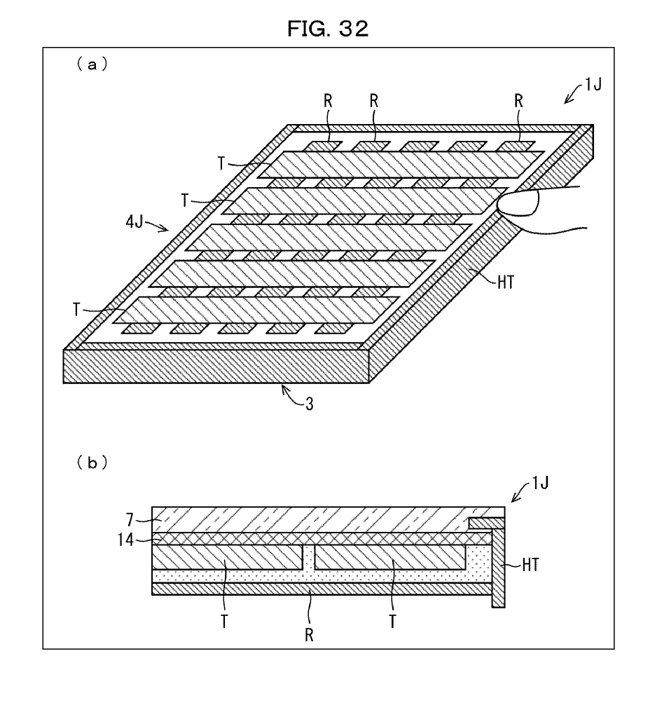

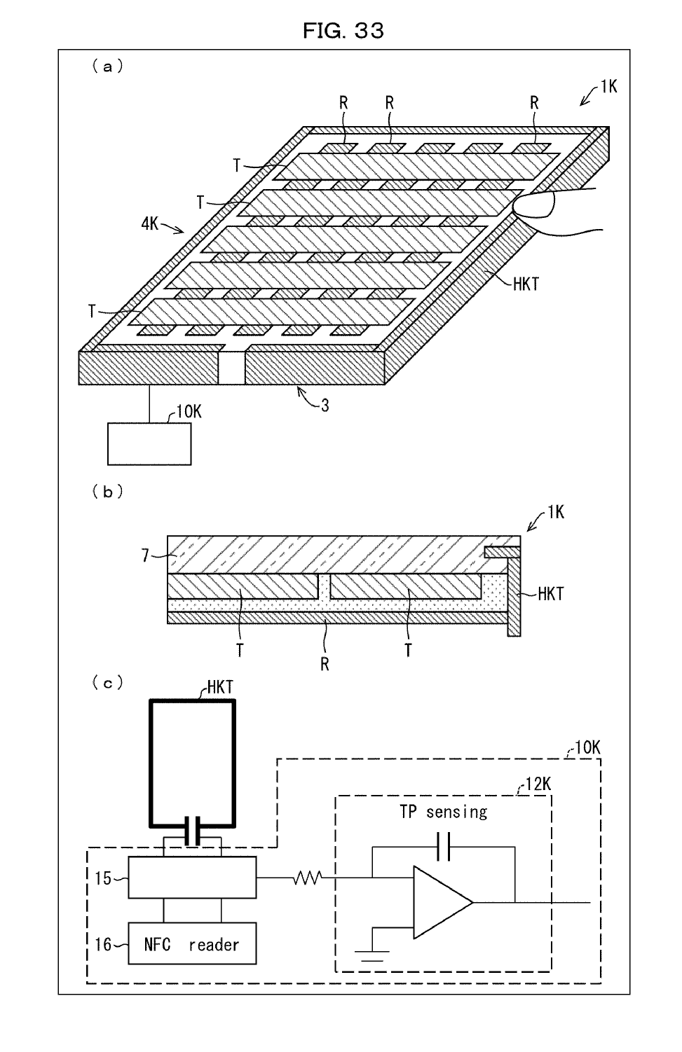

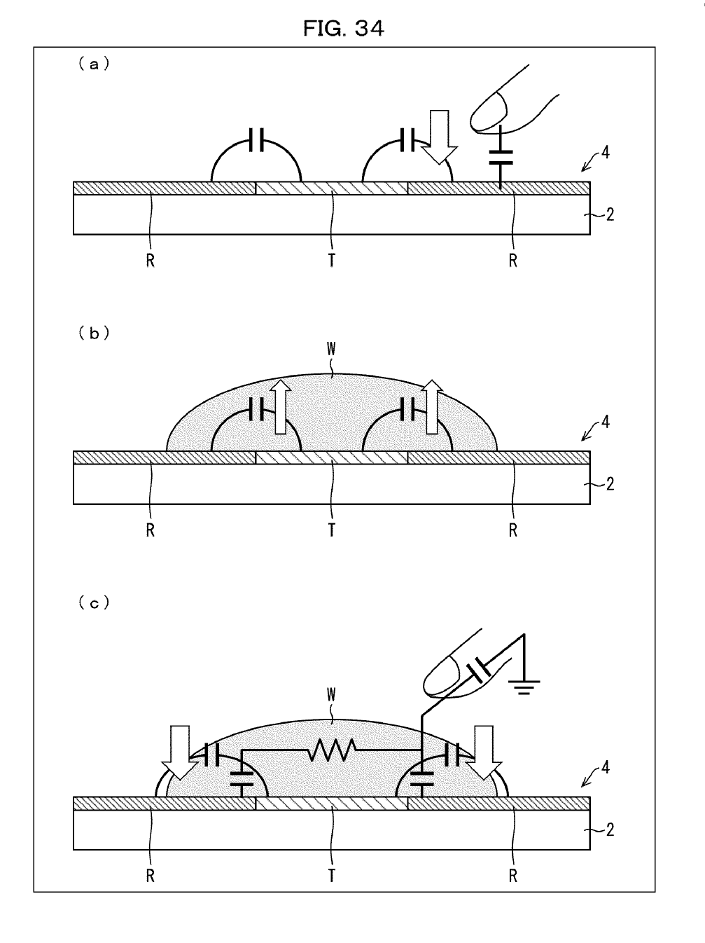

FIG. 1 is a plan view illustrating a touchscreen-equipped display device 1 in accordance with Embodiment 1. The touchscreen-equipped display device 1 includes: a liquid crystal panel 2 (display panel); a capacitive touchscreen 4 (touchscreen) which is disposed on the liquid crystal panel 2 and via which the liquid crystal panel 2 is operated; and a touchscreen controller 10 (controller) for controlling the capacitive touchscreen 4.

The capacitive touchscreen 4 includes a plurality of transmitter electrodes T, a plurality of first receiver electrodes SA, and a plurality of second receiver electrodes SB. The transmitter electrodes T, each of which extends along an X direction, are disposed in parallel to each other, and are driven by a driving voltage from the touchscreen controller 10. The first receiver electrodes SA each have, for readout of a first signal based on first capacitances between the first receiver electrode SA and the transmitter electrodes T, a base pattern 21A extending along a Y-axis direction and a plurality of comb-tooth patterns 22A each projecting from the base pattern 21A in a positive X-axis direction. The second receiver electrodes SB each have, for readout of a second signal based on second capacitances between the second receiver electrode SB and the transmitter electrodes T, a base pattern 21B extending along the Y-axis direction and a plurality of comb-tooth patterns 22B each projecting from the base pattern 21B in a negative X-axis direction. The comb-tooth patterns 22B are arranged so as to interdigitate with the comb-tooth patterns 22A.

The comb-tooth patterns 22B of the second receiver electrodes SB are more distant from the transmitter electrodes T than the comb-tooth patterns 22A of the first receiver electrodes SA are from the transmitter electrodes T.

(a), (b), (c), and (d) of FIG. 2 are cross-sectional views illustrating a concept of how the touchscreen-equipped display device 1 detects a finger wet with a water drop W.

Referring to (a) of FIG. 2, when a finger (detection target) touches a first receiver electrode SA and a second receiver electrode SB, a mutual capacitance CA (first capacitance) between the first receiver electrode SA and a transmitter electrode T decreases and a mutual capacitance CB (second capacitance) between the second receiver electrode SB and the transmitter electrode T decreases, and therefore a touch by the finger is detected.

Referring to (b) of FIG. 2, if a water drop W is present on the transmitter electrode T, the first receiver electrode SA, and the second receiver electrode SB, a significant increase is induced in the mutual capacitance CA between the first receiver electrode SA and the transmitter electrode T and in the mutual capacitance CB between the second receiver electrode SB and the transmitter electrode T because water is highly dielectric (ε=80) but also has a good electric conductivity. As such, due to the high dielectric constant of water, the changes in the mutual capacitances CA and CB are large enough to cause confusion in touch signals. As such, if the water drop W is present on the touchscreen, the mutual capacitances CA and CB increase instead of decreasing, unlike when the touchscreen is touched by a finger.

In a case where a finger touches the water drop W present on the transmitter electrode T, the first receiver electrode SA, and the second receiver electrode SB, the mutual capacitances CA and CB significantly decrease. In this case, due to the electric conductivity of water, a touch position cannot be detected accurately. As such, it is difficult for conventional touchscreen controllers to effectively prevent adverse effects from the water drop W.

Referring to (c) of FIG. 2, in Embodiment 1, a water-wetted region of the touchscreen is detected and, in the water-wetted region, a signal from the first receiver electrode SA, which is relatively close to the transmitter electrode T, and a signal from the second receiver electrode SB, which is relatively distant from the transmitter electrode T, are read out at respective different signal frequencies. This facilitates a detection of a touch to the wetted region.

In a case where the signal from the second receiver electrode SB is read out at a frequency higher than that for the signal from the first receiver electrode SA when the touchscreen, on which the water drop W is present, is touched by a finger, the mutual capacitance CB between the second receiver electrode SB and the transmitter electrode T decreases, whereas the mutual capacitance CA between the first receiver electrode SA and the transmitter electrode T stays unchanged.

In this way, the touch signal obtained when a wet touchscreen is touched is controlled, and thereby the touch position is detected accurately.

Referring to (d) of FIG. 2, in a normal dry air environment, the touch signal from the first receiver electrode SA and the touch signal from the second receiver electrode SB are read out at the same frequency or the same signal sensing parameter. In an environment in which the touchscreen is wet with water, the second receiver electrode SB can be used for readout of the touch signal, whereas the first receiver electrode SA can be used to control the touch signal from the second receiver electrode SB or a signal from the first receiver electrode SA can be used as a reference value.

(a) of FIG. 3 is a cross-sectional view illustrating a concept of how a finger wet with a water drop is detected at lower readout frequency, and (b) of FIG. 3 is a graph showing the relationship between a touch signal and a detected position in the situation of (a) of FIG. 3. (a) of FIG. 4 is a cross-sectional view illustrating a concept of how a finger wet with a water drop is detected at higher readout frequency, and (b) of FIG. 4 is a graph showing the relationship between a touch signal and a detected position in the situation of (a) of FIG. 4.

The readout frequency of a sense signal in a wet environment is preferably high in order to avoid adverse effects from the electric conductivity of water. If the readout frequency for readout of the touch signal from the second receiver electrode SB is lower, the entirety of the water-wetted region is recognized as the position touched by a finger because water behaves like a conductor. For example, as illustrated in (a) and (b) of FIG. 8, in the detected touch signal, not only peak L1, which is on the second receiver electrode SB and which corresponds to the position on the touchscreen touched by a finger, but also peak L2, which is on the first receiver electrode SA and which is in a region wet with the water drop W, appears although this region does not correspond to the position touched by a finger. This results in ambiguous detection of touch positions, ghost touching, and an increased likelihood of misrecognition on the touchscreen.

On the other hand, if the readout frequency is higher, as illustrated in (a) and (b) of FIG. 4, the touch position is detected only as peak L1 which is in a region touched by the finger, because the electric resistance of water between the second receiver electrode SB and the transmitter electrode T is high and the water behaves like an insulator.

The resistance of water is relatively high, and a capacitance between the transmitter electrode T and the second receiver electrode SB and the resistance of the water drop W function as band-pass filters. High-frequency signals pass through the capacitance, whereas low-frequency signals passes through the resistance. The water drop W, which has the characteristics of an insulator, also has a high dielectric constant (εr: 80), and therefore the capacitance from the transmitter electrode T to the second receiver electrode SB is large enough. A large-enough capacitance enables readout of touch signals at high frequency.

FIG. 5 is a circuit diagram showing a relationship between the capacitive touchscreen 4 and the touchscreen controller 10, which are included in the touchscreen-equipped display device 1.

The touchscreen controller 10 includes a sense amplifier A1. The sense amplifier A1 has a positive input terminal connected to a second receiver electrode SB and has a negative input terminal that receives a reference voltage Vref. An integrator capacitor C1 and a switch SW, which are connected in parallel with each other, are provided between the positive input terminal of the sense amplifier A1 and the output of the sense amplifier A1.

The touchscreen controller 10 includes resistors R1 and R2 connected in series with each other. The end of the resistor R1 opposite from the resistor R2 is connected to a supply voltage VDD. The resistor R2 relates to a reference value concerning a water drop W on the touchscreen.

The touchscreen controller 10 includes comparators A2, A3, and A4. The comparator A2 has a positive input terminal connected to the second receiver electrode SB and has a negative input terminal connected between the resistor R1 and the resistor R2. The comparator A3 has a negative input terminal connected to the second receiver electrode SB and has a positive terminal connected between the resistor R1 and the resistor R2. The comparator A4 has a positive input terminal connected to the second receiver electrode SB and has a negative terminal connected to the output of the comparator A4.

The touchscreen controller 10 includes transistors Tr1 and Tr2 and power supplies B1 and B2. The transistor Tr1 has a source electrode connected to a first receiver electrode SA, a drain electrode connected to the power supply B2, and a gate electrode connected to the output of the comparator A2. The transistor Tr2 has a source electrode connected to the first receiver electrode SA, a drain electrode connected to the output of the comparator A4, and a gate electrode connected to the output of the comparator A3. The power supply B1 is connected to a transmitter electrode T. An alternating current frequency f2 of the power supply B2 is higher than an alternating current frequency f1 of the power supply B1.

A signal from the second receiver electrode SB, which is more distant from the transmitter electrode T than the first receiver electrode SA is from the transmitter electrode T, enables the detection of the water drop W on the surface of the capacitive touchscreen 4. Since water has a high dielectric constant, the mutual capacitance between the transmitter electrode T and the second receiver electrode SB becomes very high when the water drop W is present on the touchscreen, and this increases the voltage value of the signal read out from the second receiver electrode SB. The voltage value of this signal is more likely to exceed a value corresponding to the integrator capacitor of the touchscreen controller, as compared with normal state (state in which no water drop is present).

If the voltage value of the signal read out from the second receiver electrode SB exceeds the reference value Vref for water drops (the reference value corresponding to the resistor R2), the transistor Tr1 is turned ON by the output of the comparator A2, and thereby, for the electric current in the sense amplifier A1 to be controlled, the power supply B2, which has the alternating current frequency f2 higher than the alternating current frequency f1 of the power supply B1, is connected to the first receiver electrode SA. Then, the value of a parameter for reference is changed.

### Operation of Touchscreen-Equipped Display Device 1

FIG. 6 is a flowchart illustrating an operation of the touchscreen-equipped display device 1. First, the calibration by the touchscreen controller 10 is carried out by resetting the amplifier and the like at least in regard to the readout of a signal from the second receiver electrode SB (step S1). Specifically, the touchscreen controller 10 carries out the calibration by comparing capacitances at all nodes with predetermined reference capacitances and using preset values for noise removal. A reference voltage Vref2, which is for a wet touchscreen on which a water drop W is present, is set higher than a reference voltage Vref1 for an environment in which the touchscreen is dry.

Then, the touchscreen controller 10 determines whether or not the capacitive touchscreen 4 has been touched by a detection target (step S2). If it is determined that the capacitive touchscreen 4 has not been touched by the detection target (NO in step S2), the process returns to step S1.

If it is determined that the capacitive touchscreen 4 has been touched by the detection target (YES in step S2), the touchscreen controller 10 creates a list of a position touched by the detection target and characteristics of the detection target (step S3). Next, the touchscreen controller 10 determines whether or not a water drop W is present on the capacitive touchscreen 4 (step S4).

In a dry environment, the power supply B1 illustrated in FIG. 5 drives the transmitter electrode T with a low-frequency signal Vin 1. Then, the low-frequency signal Vin1 from the transmitter electrode T is coupled to the first receiver electrode SA and the second receiver electrode SB. This causes the transistor Tr2 to be turned ON by the output of the comparator A3, the first receiver electrode SA to be connected to the second receiver electrode SB via the comparator A4, and the first receiver electrode SA to be maintained at the same voltage as the second receiver electrode SB (active guard).

If it is determined that a water drop W is present on the capacitive touchscreen 4 (YES in step S4), the touchscreen controller 10 increases, in a region in which the water drop is present, at least the frequency at which a signal from the second receiver electrode SB is read out (step S5). The frequency at which a signal is read out can be increased by shortening sampling time for signal readout or by changing integration time for signal readout.

If water is spilt on the touchscreen, a signal voltage read out from the second receiver electrode SB becomes higher than the reference voltage Vref2 for water drops. Then, the comparator A2 connects the first receiver electrode SA to the power supply B2, which supplies a high-frequency signal Vin2 that is higher in frequency than the low-frequency signal Vin1.

Then, parameters in respective regions are adjusted by the touchscreen controller 10 (step S6). Parameters of the touchscreen controller 10, such as capacitance gain, sampling time, and integration time, are adjusted to those for water drop environment.

If it is determined by the touchscreen controller 10 that a water drop W is not present on the capacitive touchscreen 4 (NO in step S4), or if reference values in respective regions are adjusted by the touchscreen controller 10 (step S6), the detection target and a touch position are displayed (step S7). Then, the touchscreen controller 10 starts a related application (step S8).

FIG. 7 shows graphs illustrating the results of detection of touch signals by the touchscreen-equipped display device 1. (a) of FIG. 7 illustrates the result of detection at low frequency, and (b) of FIG. 7 illustrates the result of detection at high frequency.

If the detection frequency for touch signals is low like those of conventional touchscreens, a single touch on a water-wetted touchscreen will result in multiple peaks as illustrated in (a) of FIG. 7. This prevents the detection of the touch position.

In contrast, if the detection frequency for touch signals on a water-wetted touchscreen is increased like the touchscreen-equipped display device 1 in accordance with Embodiment 1, a single touch on the wet touchscreen will result in a single peak as illustrated in (b) of FIG. 7. This makes it possible to detect the touch position.

FIG. 8 shows graphs for explaining touch signals obtained by the touchscreen-equipped display device 1 at 100 kHz in a case of a water-wetted finger. (a) of FIG. 8 shows a signal P1 in a condition in which no touch is made in a dry environment, (b) of FIG. 8 shows a signal P2 in a condition in which a touch is made in a dry environment, (c) of FIG. 8 shows a signal P3 in a condition in which no touch is made in a water drop environment, and (d) of FIG. 8 shows a signal P4 in a condition in which a touch is made in a water drop environment.

If the readout frequency is low, such as 100 kHz, in the water drop environment as shown in (c) and (d) of FIG. 8, the rise time of the signal is different from those in the dry environment as shown in (a) and (b) of FIG. 8.

FIG. 9 shows graphs for explaining touch signals obtained by the touchscreen-equipped display device 1 at 5 MHz in a case of a water-wetted finger. (a) of FIG. 9 shows a signal P5 in a condition in which no touch is made in a dry environment, (b) of FIG. 9 shows a signal P6 in a condition in which a touch is made in a dry environment, (c) of FIG. 9 shows a signal P7 in a condition in which no touch is made in a water drop environment, and (d) of FIG. 9 shows a signal P8 in a condition in which a touch is made in a water drop environment.

If the readout frequency is increased to 5 MHz, the read-out touch signals are clear both in the water drop environment and dry environment.

### Embodiment 2

The following description will discuss another embodiment of the present invention with reference to FIGS. 10 to 12. For convenience of description, members having functions identical to those of Embodiment 1 are assigned identical referential numerals and their descriptions are omitted.

FIG. 10 is a flowchart illustrating an operation of a touchscreen-equipped display device in accordance with Embodiment 2. First, a first receiver electrode SA is set as an electrode close to a transmitter electrode T, and a second receiver electrode SB is set as an electrode that is more distant from the transmitter electrode T than the first receiver electrode SA is from the transmitter electrode T (step S9). Next, the calibration by the touchscreen controller 10 is carried out (step S10). Then, the touchscreen controller 10 determines whether or not a water drop W is present on a capacitive touchscreen 4 (step S11).

If it is determined that a water drop W is present on the capacitive touchscreen 4 (YES in step S11), the touchscreen controller 10 stores the position of the water drop W into a memory (step S12). Then, the touchscreen controller 10 changes sampling time or integration time for signal readout from the first receiver electrode SA and the second receiver electrode SB (step S13). The sampling time is shortened to the extent that the touchscreen controller 10 is capable of sufficiently detecting a signal from the first receiver electrode SA, which is closer to the transmitter electrode T than the second receiver electrode SB is to the transmitter electrode T.

Next, a water drop environment mode is started (step S14). If it is determined that no water drop W is present on the capacitive touchscreen 4 (YES in step S11), or if the water drop environment mode is started (step S14), the touchscreen controller 10 determines whether or not the capacitive touchscreen 4 has been touched by a detection target (step S15).

If it is determined by the touchscreen controller 10 that the capacitive touchscreen 4 has not been touched by a detection target (NO in step S15), the process returns to step S9. If it is determined by the touchscreen controller 10 that the capacitive touchscreen 4 has been touched by a detection target (YES in step S15), the touchscreen controller 10 detects the position of the detection target that has touched the capacitive touchscreen 4 (step S16). Then, the characteristics of the detection target and position touched by the detection target are displayed (step S17.)

FIG. 11 is a flowchart illustrating another operation of the touchscreen-equipped display device in accordance with Embodiment 2. First, the first receiver electrode SA is set as an electrode close to the transmitter electrode T, and the second receiver electrode SB is set as an electrode that is more distant from the transmitter electrode T than the first receiver electrode SA is from the transmitter electrode T (step S18). Next, the calibration by the touchscreen controller 10 is carried out (step S19). Then, the touchscreen controller 10 determines whether or not the capacitive touchscreen 4 has been touched by a detection target (step S20). If it is determined by the touchscreen controller 10 that the capacitive touchscreen 4 has not been touched by a detection target (NO in step S20), the process returns to step S18.

If it is determined by the touchscreen controller 10 that the capacitive touchscreen 4 has been touched by a detection target (YES in step S20), the touchscreen controller 10 stores, into a memory, the position of the detection target that has touched the capacitive touchscreen 4 (step S21).

Then, the touchscreen controller 10 determines whether or not a water drop W is present on the capacitive touchscreen 4 (step S22). If it is determined that a water drop W is present on the capacitive touchscreen 4 (YES in step S22), the first receiver electrode SA that is closer to the transmitter electrode T than the second receiver electrode SB is to the transmitter electrode T is shielded, and a signal from the second receiver electrode SB that is more distant from the transmitter electrode T than the first receiver electrode SA is from the transmitter electrode T is read out by the touchscreen controller 10 at higher frequency (step S23). The shielding of the first receiver electrode SA can be carried out by turning OFF a switch provided between the first receiver electrode SA and the touchscreen controller 10. Shielding the first receiver electrode SA will result in a reduction in noise that would occur in the second receiver electrode SB, and in turn result in an improvement in touch position detection performance.

The frequency at which a signal from the second receiver electrode SE is read out can be increased by, for example, shortening sampling time for the readout of a signal from the second receiver electrode SB.

Then, parameters of the touchscreen controller 10 are adjusted (step S24). If it is determined that no water drop W is present on the capacitive touchscreen 4 (NO in step S22), or if the parameters of the touchscreen controller 10 are adjusted (step S24), the touchscreen controller 10 detects the position of the detection target that has touched the capacitive touchscreen 4 (step S25). After that, the characteristics of the detection target and position touched by the detection target are displayed (step S26).

(a) of FIG. 12 is a plan view illustrating patterns of transmitter electrodes T, first receiver electrodes SA, and second receiver electrodes SE provided in another touchscreen-equipped display device in accordance with Embodiment 2. (b) of FIG. 12 is a plan view illustrating another patterns of transmitter electrodes T, first receiver electrodes SA, and second receiver electrodes SB.

Referring to (a) of FIG. 12, a plurality of transmitter electrodes T, each of which extends along the X-axis direction and which are disposed in parallel to each other, each have repeating hexagonal patterns. A plurality of first receiver electrodes SA, each of which extends along the Y-axis direction, are disposed along the peripheries of the hexagonal patterns of the transmitter electrode T. A plurality of second receiver electrodes SB, each of which extends along the Y-axis direction, are located more distant from the transmitter electrodes T than the first receiver electrodes SA are from the transmitter electrodes T, and each have repeating patterns substantially in the shape of a diamond.

Wires Tw connected to the transmitter electrodes T, wires SAw connected to the first receiver electrodes SA, and wires SBw connected to the second receiver electrodes SB are disposed on a liquid crystal panel 2.

Referring to (b) of FIG. 12, a plurality of long narrow transmitter electrodes T are arranged in parallel to each other along the Y-axis direction. First receiver electrode SA's portions substantially in the shape of the letter U are disposed bridging adjacent ones of the transmitter electrodes T. A plurality of long narrow second receiver electrodes SB are provided such that their patterns are surrounded by transmitter electrode T's U-shaped portions.

In this manner, the second receiver electrodes SB are positioned more distant from the transmitter electrodes T than the first receiver electrodes SA are from the transmitter electrodes T.

Embodiments 1 and 2 exemplarily discussed configurations in which the first receiver electrodes SA and the second receiver electrodes SB (which are positioned more distant from the transmitter electrodes T than the first receiver electrodes SA are from the transmitter electrodes T) are both disposed on the front face of the liquid crystal panel 2. Note, however, that the present invention is not limited as such. A second receiver electrode SB may be disposed on a housing that houses the liquid crystal panel 2 therein. In Embodiments 3 to 8 described below, a housing transmitter electrode HT and the like may be configured as housing receiver electrodes. In a case where the housing transmitter electrode HT and the like are configured as housing receiver electrodes, a second receiver electrode SB discussed in Embodiments 1 and 2 can be used as the housing receiver electrode or the like. In this case, the first receiver electrodes SA discussed in Embodiments 1 and 2 can be used as receiver electrodes R of Embodiments 3 to 8.

As such, according to Embodiments 3 to 8 described below, it is possible to accurately detect a touch position on the housing that houses the liquid crystal panel 2 therein, even if a water drop is present on the housing.

### Embodiment 3

### Configuration of Touchscreen-Equipped Display Device 1X

FIG. 13 is a perspective view illustrating a touchscreen-equipped display device 1X in accordance with Embodiment 3. FIG. 14 is a cross-sectional view illustrating how a liquid crystal panel 2 (display panel), a capacitive touchscreen 4X, and a housing 3 of the touchscreen-equipped display device 1X are arranged. FIG. 15 is a block diagram illustrating the touchscreen-equipped display device 1X.

The touchscreen-equipped display device 1X includes: the liquid crystal panel 2; the housing 3 that is in the shape of a cuboid and that houses the liquid crystal panel 2 therein; the capacitive touchscreen 4X via which the liquid crystal panel 2 is operated; and a touchscreen controller 10X that controls the capacitive touchscreen 4X. The liquid crystal panel 2 includes: a TFT substrate 5; a cover glass 7; and a liquid crystal layer 6 that lies between the TFT substrate 5 and the cover glass 7. The capacitive touch screen 4X is disposed between the liquid crystal layer 6 and the cover glass 7. The capacitive touchscreen 4X and the TFT substrate 5 have a seal member 8 therebetween.

FIG. 16 is a plan view schematically illustrating the touchscreen-equipped display device 1X. FIG. 17 is an exploded view for explaining how the capacitive touchscreen 4X and the housing 3 of the touchscreen-equipped display device 1X are arranged. FIG. 18 is a cross-sectional view schematically illustrating the touchscreen-equipped display device 1X. FIG. 19 is a cross-sectional view schematically illustrating how transmitter electrodes T and receiver electrodes R of the capacitive touchscreen 4X and the housing 3 are connected.

The capacitive touchscreen 4X includes, on the liquid crystal panel 2: a plurality of long narrow transmitter electrodes T which are disposed in parallel to each other and which are driven by a driving voltage; and a plurality of long narrow receiver electrodes R which are disposed in parallel to each other so as to intersect the transmitter electrodes T and which are for readout of signals based on capacitances between the receiver electrodes R and the transmitter electrodes T driven by a driving voltage. The transmitter electrodes T are connected to the touchscreen controller 10X via wires 17, whereas the receiver electrodes R are connected to the touchscreen controller 10X via wires 18.

The capacitive touchscreen 4X further includes a housing transmitter electrode HT that extends continuously along four side walls of the housing and that is driven by a driving voltage. The housing transmitter electrode HT spreads along the surface of the housing 3 from the outer faces of the side walls of the housing 3 to reach the inner faces of the side walls of the housing 3, and is connected to the touchscreen controller 10X via a conductive seal member 9 disposed on the inner faces of the side walls of the housing 3 and via a wire 19.

The housing transmitter electrode HT is disposed continuously along the side walls of the housing 3, and thereby achieves easy electrode formation. For example, in a case where the housing 3 is made of metal, it is not necessary to separately provide an electrode serving as the housing transmitter electrode HT.

### Operation of Touchscreen-Equipped Display Device 1X

When the housing 3 of the touchscreen-equipped display device 1X in accordance with Embodiment 1 is touched by a finger, since the housing transmitter electrode HT is disposed on the housing 3, the capacitance between the housing transmitter electrode HT and the receiver electrodes R disposed on the front face of the liquid crystal panel 2 housed in the housing 3 changes more greatly. This is because, in a case where the housing transmitter electrode HT is disposed on the housing 3, the position of the finger is closer to the transmitter electrode than a case where the finger touches a housing of a conventional touchscreen-equipped display device in which transmitter electrodes and receiver electrodes are disposed only on the liquid crystal panel 2 and not disposed on the housing 3.

Accordingly, by reading out a signal based on a change in capacitance between the housing transmitter electrode HT and the receiver electrodes R through the receiver electrodes R and the wires 17 by the touchscreen controller 10X, it is possible to detect a finger's touch to the housing 3 with good sensitivity.

In a case where a touch to the housing 3 can be detected with good sensitivity as described above, it is not always necessary to touch the front face of the liquid crystal panel 2 with a finger, and it is possible to operate the touchscreen-equipped display device 1X by only touching the housing 3. This facilitates the operation, by one hand, of a mobile device in which the touchscreen-equipped display device 1X is installed.

(a) of FIG. 20 is a graph illustrating a touch signal distribution detected when the housing 3 of the touchscreen-equipped display device 1X is touched. (b) of FIG. 20 is a graph illustrating a touch signal distribution detected when a housing of a conventional touchscreen-equipped display device is touched. In a case where the housing transmitter electrode HT is disposed on the housing 3, a signal P having a high value peak is detected as illustrated in (a) of FIG. 20. On the other hand, in a case of the conventional touchscreen-equipped display device in which no housing transmitter electrode HT is disposed on the housing 3, no signal with a high value peak is detected as illustrated in (b) of FIG. 20, because the finger that has touched the housing 3 is distant from the transmitter electrodes T and receiver electrodes R on the liquid crystal panel 2.

### Embodiment 4

The following description will discuss a further embodiment of the present invention with reference to FIGS. 21 and 22. For convenience of description, members having functions identical to those of Embodiments 1 to 3 are assigned identical referential numerals and their descriptions are omitted.

(a) of FIG. 21 is a perspective view illustrating a touchscreen-equipped display device 1A in accordance with Embodiment 2, and (b) of FIG. 21 is a perspective view illustrating a touchscreen-equipped display device 1B in accordance with Embodiment 2.

As illustrated in (a) of FIG. 1, the touchscreen-equipped display device 1A includes a capacitive touchscreen 4A. The capacitive touchscreen 4A includes a housing transmitter electrode HAT that is disposed continuously along three side walls of a housing 3, that is in the shape of the letter U, and that is driven by a driving voltage.

As illustrated in (b) of FIG. 21, the touchscreen-equipped display device 1B includes a capacitive touchscreen 4B. The capacitive touchscreen 4B includes a housing transmitter electrode HBT that is disposed continuously along one side wall of a housing 3, that is in the shape of the letter I, and that is driven by a driving voltage.

The housing transmitter electrodes HAT and HBT are disposed continuously along the side wall(s) of the housing 3, and thereby achieve easy electrode formation. For example, in a case where the housing 3 is made of metal, it is not necessary to separately provide an electrode serving as the housing transmitter electrode HAT or HBT.

FIG. 22 is a perspective view of a touchscreen-equipped display device 1C in accordance with Embodiment 2. A capacitive touchscreen 4C of the touchscreen-equipped display device 1C includes, as illustrated in FIG. 22, a plurality of separate housing transmitter electrodes HCT disposed along a side wall of a housing 3. The housing transmitter electrodes HCT are disposed on the outer face of the side wall of the housing 3.

According to this configuration, since a plurality of housing transmitter electrodes HCT are disposed on a side wall of the housing 3, resolution in detection of a touch to the side wall of the housing 3 improves.

### Embodiment 5

The transmitter electrodes T and receiver electrodes R in Embodiments 1 to 4 have long narrow patterns. Note, however, that the present invention is not limited as such.

FIG. 23 is a plan view illustrating a touchscreen-equipped display device 1D in accordance with Embodiment 5. Members having functions identical to those of Embodiments 1 to 4 are assigned identical referential numerals and their descriptions are omitted.

A capacitive touchscreen 4D of the touchscreen-equipped display device 1D includes: a plurality of transmitter electrodes TD arranged in parallel to each other and driven by a driving voltage; and a plurality of receiver electrodes RD that are arranged in parallel to each other so as to intersect the transmitter electrodes TD and that are for readout of signals based on capacitances between the receiver electrodes RD and the transmitter electrodes TD driven by a driving voltage.

Each of the transmitter electrodes TD has repeating patterns substantially in the shape of a diamond along the X-axis direction. Each of the receiver electrodes RD has repeating patterns substantially in the shape of an octagon along the Y-axis direction.

### Embodiment 6

The housing transmitter electrode HT of the housing 3 in Embodiments 3 to 5 is connected, via the conductive seal member 9, to the wire 19 coupled to the touchscreen controller 10. Note, however, that the present invention is not limited as such.

(a) and (b) of FIG. 24 are cross-sectional views schematically illustrating how a wire 19 provided to a touchscreen of a touchscreen-equipped display device in accordance with Embodiment 6 is connected to a housing transmitter electrode HT disposed on a housing 3. Members having functions identical to those of Embodiments 1 to 5 are assigned identical referential numerals and their descriptions are omitted.

As illustrated in (a) of FIG. 24, the housing transmitter electrode HT may be connected to the wire 19 via a flexible connector 11.

Alternatively, as illustrated in (b) of FIG. 24, the housing transmitter electrode HT may be connected to the wire 19 via a cover glass 7.

### Embodiment 7

The housing 3 discussed in Embodiments 3 to 6 has the shape of a cuboid. Note, however, that the present invention is not limited as such.

(a) of FIG. 25 is a plan view schematically illustrating a touchscreen-equipped display device 1E in accordance with Embodiment 5, and (b) of FIG. 25 is a cross-sectional view schematically illustrating the touchscreen-equipped display device 1E. (a) of FIG. 26 is a plan view schematically illustrating a conventional touchscreen-equipped display device 91E, and (b) of FIG. 26 is a cross-sectional view schematically illustrating the touchscreen-equipped display device 91E. Members having functions identical to those of Embodiments 1 to 6 are assigned identical referential numerals and their descriptions are omitted.

The touchscreen-equipped display device 91E, which is a conventional touchscreen-equipped display device in the shape of a circular disk, has no electrodes on a housing 3E as illustrated in (a) and (b) of FIG. 26. Even when the housing 3E is touched, a detection signal is low and the touch is difficult to detect.

The touchscreen-equipped display device 1E has a housing 3E which is in the shape of a circular disk as illustrated in (a) of FIG. 25. The housing 3E houses therein a display panel in the shape of a circular disk (not illustrated). On the display panel in the shape of a circular disk, a circular capacitive touchscreen 4E is disposed. The capacitive touchscreen 4E has a housing transmitter electrode HET that covers the peripheral portion of the front face of the housing 3E and the side face of the housing 3E.

The capacitive touchscreen 4E includes, on the display panel: a plurality of long narrow transmitter electrodes T that are arranged in parallel to each other and that are driven by a driving voltage; and a plurality of long narrow receiver electrodes R that are arranged in parallel to each other so as to intersect the transmitter electrodes T and that are for readout of signals based on capacitances between the receiver electrodes R and the transmitter electrodes T driven by a driving voltage.

(a) of FIG. 27 is a plan view schematically illustrating a touchscreen-equipped display device 1F in accordance with Embodiment 5, and (b) of FIG. 27 is a cross-sectional view schematically illustrating the touchscreen-equipped display device 1F.

The touchscreen-equipped display device 1F includes a capacitive touchscreen 4F, which has a housing transmitter electrode HFT disposed on a housing 3E in the shape of a circular disk and which has a plurality of square receiver electrodes R arranged in a matrix manner on a display panel.

Even in a case of a simple configuration in which the electrodes on the display panel are constituted only by the receiver electrodes R as described above, the housing transmitter electrode HFT disposed on the housing 3E makes it possible to detect a touch position on the housing 3E with high sensitivity.

In a case where the housing 3E is in the shape of a circular disk as illustrated in FIGS. 25 and 27, when, for example, the touchscreen-equipped display device 1E or 1F is installed as a sound volume indicator of an acoustic instrument in an automobile, the following can be achieved because a touch to the side face of the housing 3E can be detected: the sound volume can be adjusted by moving a finger along the side face of the housing 3E (this action may be hereinafter referred to as “trace with a finger”). Tracing the side face of the housing 3 with a finger should achieve better operational feeling than tracing the front face of the touchscreen with a finger. Furthermore, tracing the side face of the housing 3E with a finger should be easier than tracing the front face of the touchscreen with a finger and this should contribute to improvements in handleability and safety when operation is carried out during driving.

(a) of FIG. 28 is a plan view schematically illustrating a touchscreen-equipped display device 1G in accordance with Embodiment 5, and (b) of FIG. 28 is a cross-sectional view schematically illustrating the touchscreen-equipped display device 1G. (a) of FIG. 29 is a plan view schematically illustrating a conventional touchscreen-equipped display device 91G, and (b) of FIG. 29 is a cross-sectional view schematically illustrating the touchscreen-equipped display device 91G.

The touchscreen-equipped display device 91G, which is a conventional touchscreen-equipped display device having an irregular shape, has no electrodes on a housing 3G as illustrated in (a) and (b) of FIG. 29, and therefore, even when the housing 3G is touched, a detection signal is low and the touch is difficult to detect.

The touchscreen-equipped display device 1G has a housing 3G, which has, as illustrated in (a) of FIG. 28, an irregular shape that is constituted by a horizontally long rectangle with rounded corners at the upper left and upper right when viewed from front, and which houses therein a display panel having the irregular shape (not illustrated). On the display panel having the irregular shape, an irregular shaped capacitive touchscreen 4G is disposed. The capacitive touchscreen 4G has a housing trans transmitter electrode HGT that covers the peripheral portion of the front face of the housing 3G and the side face of the housing 3G.

### Embodiment 8

(a) of FIG. 30 is a perspective view illustrating a touchscreen-equipped display device 1H in accordance with Embodiment 6, and (b) of FIG. 30 is a circuit diagram of a proximity sensor provided to the touchscreen-equipped display device 1H. Members having functions identical to those of Embodiments 1 to 7 are assigned identical referential numerals and their descriptions are omitted.

The touchscreen-equipped display device 1H includes a capacitive touchscreen 4H and a touchscreen controller 10H that controls the capacitive touchscreen 4H. The capacitive touchscreen 4H includes a housing transmitter electrode HT that continuously extends along four side walls of a housing 3 and that is driven by a driving voltage.

In conventional capacitive touchscreens, there are limitations on the shapes, widths (5 mm), and areas of transmitter electrodes and receiver electrodes, and therefore it is difficult for the conventional capacitive touchscreens to achieve a proximity sensor function.

The housing transmitter electrode HT in accordance with Embodiment 6 is in the form of a loop, and can have larger areas than transmitter electrodes T and receiver electrodes R disposed on the front face of the display panel. Therefore, by employing a touchscreen controller 10H which includes an amplifier 12H that receives a signal from a receiver electrode R corresponding to the housing transmitter electrode HT and a reference voltage corresponding to the housing transmitter electrode HT as illustrated in (b) of FIG. 30, it is possible for the touchscreen-equipped display device 1H to achieve a proximity sensor function.

That is, the touchscreen controller 10H is capable of detecting a target near the housing transmitter electrode HT, and is also capable of determining the characteristics of the target near the housing transmitter electrode HT. For example, the touchscreen controller 10H is capable of determining whether the target near the housing transmitter electrode HT is a hand or a cover for a mobile terminal in which the touchscreen-equipped display device 1H is installed. Therefore, it is possible to achieve a configuration in which, if a cover for a mobile terminal approaches the housing 3, the touchscreen controller 10H automatically turns OFF the power supply to the touchscreen-equipped display device 1H, and is also possible to display, on a liquid crystal panel 2, a user interface (UI) that gives a feedback reaction when a hand approaches the housing 3. This improves operability of the touchscreen-equipped display device 1H.

When a sensitive material is attached to a human's hand or a housing, the hand or housing is connected to the UI that is capable of feedback.

(a) of FIG. 31 is a perspective view illustrating a touchscreen-equipped display device 1I in accordance with Embodiment 6, (b) of FIG. 31 is a cross-sectional view schematically illustrating the touchscreen-equipped display device 1I, and (c) of FIG. 31 is a circuit diagram of an environment sensor provided to the touchscreen-equipped display device 1I.

The touchscreen-equipped display device 1I includes: a capacitive touchscreen 4I: and a touchscreen controller 10I that controls the capacitive touchscreen 4I. The capacitive touchscreen 4I includes a housing transmitter electrode HT that extends continuously along four side walls of a housing 3 and that is driven by a driving voltage.

It is difficult for a conventional capacitive touchscreen to determine whether an object touching the touchscreen is a conductor or a nonconductor.

As illustrated in (c) of FIG. 31, the touchscreen controller 10I includes an amplifier 12I that receives a signal from a receiver electrode R corresponding to the housing transmitter electrode HT and a signal corresponding to a transmitter electrode T, in order to determine whether an object 13 touching the touchscreen is a conductor or a nonconductor.

Assume that, as illustrate in (b) of FIG. 31, a transmitter electrode T and a receiver electrode R are disposed on a front face of a display panel, and the housing transmitter electrode HT is more distant from the receiver electrode R than the transmitter electrode T is from the receiver electrode R. In this case, if the object touching the touchscreen is a conductor, a coupling capacitance between the transmitter electrode T and the receiver electrode R and a coupling capacitance between the housing transmitter electrode HT and the receiver electrode R both decrease as the conductor approaches the touchscreen. On the other hand, if the object touching the touchscreen is a nonconductor, the coupling capacitance between the transmitter electrode T and the receiver electrode R increases as the nonconductor approaches the touchscreen, whereas the coupling capacitance between the receiver electrode R and the housing transmitter electrode HT, which is more distant from the receiver electrode R than the transmitter electrode T is from the receiver electrode R, decreases as the nonconductor approaches the touchscreen.

On the basis of such tendencies of increase and decrease of coupling capacitances, the touchscreen controller 10I determines whether the object 13 touching the touchscreen is a conductor or a nonconductor. This makes it possible to determine, for example, whether the object 13 touching the touchscreen is a finger (conductor) or a glove (nonconductor), and thus possible for the touchscreen controller 10I to switch operation modes on the basis of the result of the determination. In this way, the touchscreen controller 10I switches operation modes based on the recognition of an environment in which the object 13 touching the touchscreen is a conductor or a nonconductor. This reduces misrecognitions and achieves low power consumption.

(a) of FIG. 32 is a perspective view illustrating a touchscreen-equipped display device 1J in accordance with Embodiment 6, and (b) of FIG. 32 is a cross-sectional view schematically illustrating the touchscreen-equipped display device 1J.

The touchscreen-equipped display device 1J includes a capacitive touchscreen 4J. The capacitive touchscreen 4J includes, on a display panel: a plurality of long narrow transmitter electrodes T which are disposed in parallel to each other and which are driven by a driving voltage; and a plurality of long narrow receiver electrodes R which are disposed in parallel to each other so as to intersect the transmitter electrodes T and which are for readout of signals based on capacitances between the receiver electrodes R and the transmitter electrodes T driven by a driving voltage. The capacitive touchscreen 4J further includes: a housing transmitter electrode HT that extends continuously along four side walls of a housing 3 and that is driven by a driving voltage; and a pressure sensitive material 14 that is disposed between the transmitter electrodes T and the housing transmitter electrode HT and that is sensitive to pressure.

Since the transmitter electrodes T and the receiver electrode R are disposed on the same substrate on the display panel, the thickness of each electrode, the distance between electrodes, and capacitances are fixed.

It is difficult for a conventional capacitive touchscreen to carry out pressure sensing. In the touchscreen-equipped display device 1J in accordance with Embodiment 8, the pressure sensitive material 14, which is sensitive to pressure, is disposed between the housing transmitter electrode HT and the transmitter electrodes T. Therefore, a capacitance between the housing transmitter electrode HT and the receiver electrodes R changes depending on the pressure sensitive material 14 which is sensitive to pressure. As such, by reading out, through the receiver electrodes R, a signal based on the capacitances that form between the housing transmitter electrode HT and the receiver electrodes R and that change depending on the pressure sensitive material 14, and analyzing the signal, it is possible to detect the pressure acting on the capacitive touchscreen 4J.

According to this configuration, it is possible to differentiate a feather-touch input and a touch input with a strong pressing force. This enables input of letters with a strong pressing force without misrecognitions, and thus facilitates the letter input.

(a) of FIG. 32 is a perspective view of a touchscreen-equipped display device 1K in accordance with Embodiment 8, (b) of FIG. 32 is a cross-sectional view schematically illustrating the touchscreen-equipped display device 1K, and (c) of FIG. 32 is a block diagram illustrating a relationship between a loop antenna, a near field communication (NFC) reader 16, and an amplifier 12K (sense circuit), which are provided to the touchscreen-equipped display device 1K.

The touchscreen-equipped display device 1K includes: a capacitive touchscreen 4K; and a touchscreen controller 10K that controls the capacitive touchscreen 4K. The capacitive touchscreen 4K includes a housing transmitter electrode HKT which extends along four side walls of a housing 3, which is in the form of a loop, and which is driven by a driving voltage.

As illustrated in (c) of FIG. 33, the touchscreen controller 10K includes: the NFC reader 16; the amplifier 12K that amplifies a signal read out through a receiver electrode R; and a switch 15 that connects the housing transmitter electrode HKT to the NFC reader 16 or to the amplifier 12K.

In a conventional touchscreen-equipped display device, an NFC antenna is provided separately from a capacitive touchscreen. In the touchscreen-equipped display device 1K in accordance with Embodiment 8, the housing transmitter electrode HKT functions as an NFC antenna when the switch 15 connects the housing transmitter electrode HKT to the NFC reader 16. This eliminates the need for separately providing an NFC antenna.

Embodiments 3 to 8 described above dealt with examples in which a transmitter electrode (housing transmitter electrode) is disposed on a housing. Note, however, that the present invention is not limited as such. A receiver electrode (housing receiver electrode) may be disposed on a housing, or both a transmitter electrode (housing transmitter electrode) and a receiver electrode (housing receiver electrode) may be disposed on a housing, provided that at least one of a transmitter electrode (housing transmitter electrode) and a receiver electrode (housing receiver electrode) is disposed on a housing.

### Recap

A touchscreen-equipped display device 1 in accordance with Aspect 1 of the present invention includes: a display panel (liquid crystal panel 2); a touchscreen (capacitive touchscreen 4) via which the display panel (liquid crystal panel 2) is operated; and a controller (touchscreen controller 10) configured to control the touchscreen (capacitive touchscreen 4), the touchscreen (capacitive touchscreen 4) including: a transmitter electrode T configured to be driven by a driving voltage; a first receiver electrode SA for readout of a first signal based on a first capacitance between the first receiver electrode SA and the transmitter electrode T; and a second receiver electrode SB that is more distant from the transmitter electrode T than the first receiver electrode SA is from the transmitter electrode T and that is for readout of a second signal based on a second capacitance between the second receiver electrode SB and the transmitter electrode T, the controller (touchscreen controller 10) being configured to, when a water drop is present on the touchscreen (capacitive touchscreen 4), increase a frequency at which the second signal is read out.

According to the above configuration, when water drop is present on the touchscreen, the frequency at which the second signal based on the second capacitance between the second receiver electrode (which is more distant from the transmitter electrode than the first receiver electrode is from the transmitter electrode) and the transmitter electrode is read out is increased. This makes it possible to accurately detect a touch position on the touchscreen on which the water drop is present.

A touchscreen-equipped display device 1 in accordance with Aspect 2 of the present invention may be configured such that, in Aspect 1, the controller (touchscreen controller 10) increases the frequency by shortening sampling time for readout of the second signal.

The above configuration achieves a simple configuration to increase the frequency at which the second signal is read out.

A touchscreen-equipped display device 1 in accordance with Aspect 3 of the present invention may be configured such that, in Aspect 1, the controller (touchscreen controller 10) is configured to, when a water drop is present on the touchscreen (capacitive touchscreen 4), increase a frequency at which the first signal is read out.

According to the above configuration, it is possible to more accurately detect a touch position on the touchscreen on which a water drop is present.

A touchscreen-equipped display device 1 in accordance with Aspect 4 of the present invention may be configured such that, in Aspect 1, when a water drop is present on the touchscreen (liquid crystal panel 2), the first receiver electrode SA is shielded.

According to the above configuration, it is possible to more accurately detect a touch position on the touchscreen on which a water drop is present.

A touchscreen-equipped display device 1 in accordance with Aspect 5 of the present invention may be configured such that, in Aspect 1, the touchscreen-equipped display device 1 further includes a housing 3 for housing the display panel (liquid crystal panel 2), and the second receiver electrode SB is disposed on the housing 3.

According to the above configuration, it is possible to accurately detect a touch position on the housing that houses the display panel therein, even when a water drop is present on the housing.

A touchscreen-equipped display device 1 in accordance with Aspect 6 of the present invention may be configured such that, in Aspect 5: the second receiver electrode SB is disposed on a side face of the housing 3; and the transmitter electrode T and the first receiver electrode SB are disposed on a front face of the display panel (liquid crystal panel 2).

According to the above configuration, it is possible to: detect a touch to the side face of the housing on the basis of a change in capacitance between the transmitter electrode and the second receiver electrode; and detect a touch to the front face of the display panel on the basis of a change in capacitance between the transmitter electrode and the first receiver electrode.

A touchscreen-equipped display device 1 in accordance with Aspect 7 of the present invention may be configured such that, in Aspect 5, a wire 19 disposed on the front face of the display panel (liquid crystal panel 2) is connected to the second receiver electrode (housing receiver electrode) disposed on the housing 3.

According to the above configuration, the second receiver electrode disposed on the housing can be connected to the controller via the wire disposed on the front face of the display panel.

A touchscreen-equipped display device 1 in accordance with Aspect 8 of the present invention may be configured such that, in Aspect 1, the transmitter electrode T, the first receiver electrode SA, and the second receiver electrode SB are disposed on the front face of the display panel (liquid crystal panel 2).

According to the above configuration, it is possible to accurately detect a touch position on a housing even when a water drop is present on the front face of the display panel.

A touchscreen-equipped display device 1 in accordance with Aspect 9 of the present invention may be configured such that, in Aspect 8; a plurality of the transmitter electrodes T, each extending in a first direction, are disposed in parallel to each other; the first receiver electrode SA is in a comb-like shape that has a plurality of first receiver projecting patterns (comb-tooth patterns 22A) corresponding to the plurality of transmitter electrodes T; and the second receiver electrode SB is in a comb-like shape that has a plurality of second receiver projecting patterns (comb-tooth pattern 22B) each projecting in a second direction, the plurality of second receiver projecting patterns (comb-tooth pattern 22B) interdigitating with the plurality of first receiver projecting patterns (comb-tooth pattern 22A), the second direction being a direction reverse to the first direction.

According to the above configuration, the first receiver projecting patterns and the second receiver projecting patterns interdigitate with each other, and thereby touch signals can be detected with improved sensitivity.

A touchscreen-equipped display device 1 in accordance with Aspect 10 of the present invention may be configured such that, in Aspect 1, the controller (touchscreen controller 10) determines whether a detection target is a conductor or a nonconductor on the basis of a characteristic of how the first capacitance changes as the detection target approaches the touchscreen (capacitive touchscreen 4) and a characteristic of how the second capacitance changes as the detection target approaches the touchscreen (capacitive touchscreen 4).

According to the above configuration, it is possible to determine whether a detection target is a conductor or a nonconductor. This makes it possible to, for example, differentiate a touch from a bare finger and a touch from a finger covered in a glove.

A touchscreen-equipped display device 1 in accordance with Aspect 11 of the present invention may be configured such that, in Aspect 10: if the detection target is a conductor, the first capacitance and the second capacitance decrease as the detection target approaches the touchscreen; and if the detection target is a nonconductor, the first capacitance decreases as the detection target approaches the touchscreen and the second capacitance increases as the detection target approaches the touchscreen.

According to the above configuration, it is possible to determine whether a detection target is a conductor or a nonconductor with the use of a simple algorithm.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### Reference Signs List

1 Touchscreen-equipped display device
2 Liquid crystal panel (display panel)
3 Housing
4 Capacitive touchscreen (touchscreen)
10 Touchscreen controller (controller)
T Transmitter electrode
SA First receiver electrode
SB Second receiver electrode
W Water drop

1. A touchscreen-equipped display device comprising:
a display panel;
a touchscreen via which the display panel is operated; and
a controller configured to control the touchscreen,
the touchscreen including
a transmitter electrode configured to be driven by a driving voltage,
a first receiver electrode for readout of a first signal based on a first capacitance between the first receiver electrode and the transmitter electrode, and
a second receiver electrode that is more distant from the transmitter electrode than the first receiver electrode is from the transmitter electrode and that is for readout of a second signal based on a second capacitance between the second receiver electrode and the transmitter electrode,
the controller being configured to, when a water drop is present on the touchscreen, increase a frequency at which the second signal is read out.

2. The touchscreen-equipped display device according to claim 1, wherein the controller increases the frequency by shortening sampling time for readout of the second signal.

3. The touchscreen-equipped display device according to claim 1, wherein the controller is configured to, when a water drop is present on the touchscreen, increase a frequency at which the first signal is read out.

4. The touchscreen-equipped display device according to claim 1, wherein, when a water drop is present on the touchscreen, the first receiver electrode is shielded.

5. The touchscreen-equipped display device according to claim 1, further comprising a housing for housing the display panel,
the second receiver electrode being disposed on the housing.

6. The touchscreen-equipped display device according to claim 5, wherein:
the second receiver electrode is disposed on a side face of the housing; and
the transmitter electrode and the first receiver electrode are disposed on a front face of the display panel.

7. The touchscreen-equipped display device according to claim 5, wherein a wire disposed on a front face of the display panel is connected to the second receiver electrode disposed on the housing.

8. The touchscreen-equipped display device according to claim 1, wherein the transmitter electrode, the first receiver electrode, and the second receiver electrode are disposed on a front face of the display panel.

9. The touchscreen-equipped display device according to claim 8, wherein:
a plurality of the transmitter electrodes, each extending in a first direction, are disposed in parallel to each other;
the first receiver electrode is in a comb-like shape that has a plurality of first receiver projecting patterns corresponding to the plurality of transmitter electrodes; and
the second receiver electrode is in a comb-like shape that has a plurality of second receiver projecting patterns each projecting in a second direction, the plurality of second receiver projecting patterns interdigitating with the plurality of first receiver projecting patterns, the second direction being a direction reverse to the first direction.

10. The touchscreen-equipped display device according to claim 1, wherein the controller determines whether a detection target is a conductor or a nonconductor on the basis of a characteristic of how the first capacitance changes as the detection target approaches the touchscreen and a characteristic of how the second capacitance changes as the detection target approaches the touchscreen.

11. The touchscreen-equipped display device according to claim 10, wherein:
if the detection target is a conductor, the first capacitance and the second capacitance decrease as the detection target approaches the touchscreen; and
if the detection target is a nonconductor, the first capacitance decreases as the detection target approaches the touchscreen and the second capacitance increases as the detection target approaches the touchscreen.
